(19) United States
(12) Patent Application Publication
(10) Pub. No.: US 2009/0025595 A1
(43) Pub. Date: Jan. 29, 2009

(54) Contact Printing Method Using an Elastomeric Stamp Having a Variable Surface Area and Variable Shape

(75) Inventors: Brian T. MAYERS, Somerville, MA (US); Jeffrey CARBECK, Belmont, MA (US); Karan CHAUHAN, Cambridge, MA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Nano Terra Inc., Cambridge, MA (US)

(21) Appl. No.: 12/179,162

(22) Filed: Jul. 24, 2008

Related U.S. Application Data
(60) Provisional application No. 60/951,807, filed on Jul. 25, 2007.

(51) Int. Cl. B41D 7/04

(52) U.S. Cl. 101/492; 101/493

(57) ABSTRACT

The present invention is directed to methods for patterning substrates by contact printing methods using tools that include continuous, flexible surfaces having variable surface areas and variable shapes.

### CROSS-REFERENCE TO RELATED APPLICATIONS

This application claims the benefit of the filing date of U.S. Provisional Appl. No. 60/951,807, filed Jul. 25, 2007, which is incorporated herein by reference in its entirety.

### STATEMENT OF GOVERNMENT RIGHTS

This invention was supported by U.S. Government Contract Number W31P4Q-07-C-0081. The U.S. Government may have certain rights in this invention.

### BACKGROUND OF THE INVENTION

1. Field of the Invention

The present invention is directed to methods for patterning a surface using contact printing methods that employ a stamp having a variable surface area and variable shape and lacking a rigid backing.

2. Background

Patterning surfaces (e.g., with topographies or with chemical, electrical, mechanical, and/or thermal material functionalities) is an important step in many industries. Methods of patterning surfaces are well known and include photolithography techniques. Traditional photolithography methods, while versatile in the architectures and compositions of surface features to be formed, are costly, require specialized equipment, and have difficulty patterning curved surfaces and irregular three-dimensional objects.

More recently, soft-lithographic printing methods such as micro-contact printing (“μCP”), micro-transfer molding (“μTM”), and micro-molding in capillaries (“MIMIC”) have demonstrated the ability to produce patterned substrates including features having a lateral dimension as small as 40 nm. Compared to photolithography, soft-lithographic methods have a significantly reduced equipment cost. Nonetheless, surfaces that are curved in two or more dimensions (e.g., spheres, cones, and the like) can be difficult to pattern using soft lithographic printing methods.

Because stamps utilized in soft lithography are typically constructed from flexible materials, distortion of a stamp due to thermal effects, mechanical effects, and the like can lead to unwanted pattern distortion. To overcome this, most soft lithographic stamps are affixed to a rigid backing layer that prevents unwanted distortion of the stamp (see, e.g., U.S. Pat. No. 7,117,790 B2). Elastomeric stamps having a rigid backing layer can be distorted to facilitate conformal contact between the stamp and a substrate. However, the patterning of non-planar substrates has required the use of pressure transducers within the stamp and/or backing layer to facilitate distortion of the stamp surface and conformal contact between the stamp and the non-planar substrate.

In addition to reproducing a specific surface pattern, the ability to controllably distort a pattern has also been demonstrated by applying lateral pressure to flat elastomeric stamps (see, e.g., Xia, Y. and Whitesides, G. M., Adv. Mater. 7:471 (1995); Xia, Y. et al., Science 273:347 (1996); and Xia, Y. and Whitesides, G. M., Langmuir 13:2059 (1997)). However, lateral compression typically leads to pattern broadening, and has not been extended to complex and/or curved substrates.

What is needed is an inexpensive method for patterning non-planar substrates that ensures conformal contact between an elastomeric stamp and a substrate. Additionally, a printing technique is needed that can reliably pattern complex (i.e., non-planar) surfaces in a cost-effective manner with patterns comprising features having lateral dimensions of about 100 μm or less.

### BRIEF SUMMARY OF THE INVENTION

The present invention is directed to patterning substrates using contact-printing techniques that employ an elastomeric stamp and an ink. Surface features formed by the method of the present invention have at least one lateral dimension of about 100 microns or less, and permit all varieties of substrates to be patterned in a cost-effective, efficient, and reproducible manner.

The present invention is directed to a method for patterning a substrate, the method comprising:
providing a tool including a continuous, flexible surface having an area, wherein the continuous, flexible surface does not include a rigid backing layer;
applying an ink to at least a portion of the continuous, flexible surface of the tool to form an ink pattern thereon;
applying homogeneous pressure to a backside of the continuous, flexible surface to distort the surface area of the continuous, flexible surface;
conformally contacting at least a portion of the distorted continuous, flexible surface of the tool with a non-planar substrate; and
transferring the ink pattern from the distorted continuous, flexible surface of the tool to the non-planar substrate, wherein the pattern on the non-planar substrate includes at least one feature having a lateral dimension of about 100 μm or less.

The present invention is also directed to a method for patterning a non-planar substrate, the method comprising:
providing a tool including a continuous, flexible surface having an area;
applying an ink to at least a portion of the continuous, flexible surface of the tool to form an ink pattern thereon;
applying homogeneous pressure to a backside of the continuous, flexible surface to distort the surface area of the continuous, flexible surface of the tool while restraining an edge of the continuous, flexible surface;
conformally contacting at least a portion of the distorted continuous, flexible surface of the tool with a non-planar substrate; and
transferring the ink pattern from the distorted continuous, flexible surface of the tool to the non-planar substrate, wherein the pattern on the non-planar substrate has a lateral dimension of about 100 μm or less.

The present invention is also directed to a method for patterning a planar or non-planar substrate, the method comprising:
providing a tool including a continuous, flexible surface having a raised pattern thereon;
applying an ink to at least a portion of a planar or non-planar substrate;
applying homogeneous pressure to a backside of the continuous, flexible surface to distort the raised pattern of the continuous, flexible surface of the tool; and
patterning the ink on the planar or non-planar substrate by conformally contacting at least a portion of the distorted raised pattern of the tool with the inked substrate, wherein the resulting pattern on the substrate includes a feature having a lateral dimension of about 100 μm or less.

In some embodiments, a non-planar substrate comprises an interior surface of at least one of: a spheroid, a hemispheroid, an ellipsoid, a cone, a polyhedron, a cylinder, a toroid, a trigonal pyramid, and a square pyramid.

In some embodiments, a non-planar substrate comprises an exterior surface of at least one of: a spheroid, a hemispheroid, an ellipsoid, a cone, a polyhedron, a cylinder, a toroid, a trigonal pyramid, and a square pyramid.

In some embodiments, the continuous, flexible surface of the tool encloses a volume comprising at least one of: a spheroid, a hemispheroid, a toroid, a polyhedron, a cone, a cylinder, a trigonal pyramid, and a square pyramid.

In some embodiments, the continuous, flexible surface of the tool is non-porous. In some embodiments, the continuous, flexible surface of the tool is non-porous and substantially impermeable to the ink.

In some embodiments, the continuous, flexible surface of the tool includes at least one protrusion thereon, the protrusion being contiguous with and defining a pattern in the surface of the tool.

In some embodiments, the applying an ink to at least a portion of the continuous, flexible surface of the tool further comprises applying the ink from a reservoir enclosed within the volume of the continuous, flexible surface of the tool, wherein the reservoir is configured to receive an ink, and wherein the reservoir is in fluid communication with at least a portion of the continuous, flexible surface.

In some embodiments, the applying an ink comprises contacting the continuous, flexible surface of the tool with a stamp having a surface including at least one indentation therein, the indentation being contiguous with and defining a pattern in the surface of the stamp.

In some embodiments, the transferring comprises forming a self-assembled monolayer on an area of the non-planar substrate defined by the pattern. In some embodiments, the ink comprises a species suitable for forming a self-assembled monolayer on a substrate, and the pattern on the substrate includes a feature having a lateral dimension of about 10 μm or less.

In some embodiments, the ink comprises a polymeric species, and the pattern on the substrate includes a feature having a lateral dimension of about 10 μm or less.

In some embodiments, the distorting comprises applying homogeneous pressure to the continuous, flexible surface of the tool. In some embodiments, the distorting changes the area of the ink pattern in a ratio proportional to the change in the area of the continuous, flexible surface of the tool. In some embodiments, the distorting comprises increasing a volume enclosed by the continuous, flexible surface of the tool. In some embodiments, the distorting comprises decreasing a volume enclosed by the continuous, flexible surface of the tool. In some embodiments, the distorting changes the area of the raised pattern in a ratio proportional to the change in the area of the continuous, flexible surface of the tool.

In some embodiments, the distorting and the contacting are simultaneous. In some embodiments, the contacting further distorts the surface area of the continuous, flexible surface of the tool.

In some embodiments, the method further comprises removing the distorted raised pattern from the non-planar substrate.

The present invention is also directed to a method to prepare a patterning tool having a continuous, flexible surface including at least one protrusion thereon, the method comprising:
applying an elastomeric precursor to a master having a predetermined relief pattern thereon;
contacting a continuous, flexible surface with the elastomeric precursor;
curing the elastomeric precursor to provide a patterning tool including at least one elastomeric protrusion thereon, wherein the at least one protrusion corresponds to the relief pattern of the master, and the continuous, flexible surface and the at least one protrusion have a Young's modulus that is substantially identical; and
removing the patterning tool from the master.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A-1D provide representations of patterned substrates prepared by a method of the present invention.

FIG. 2 provides a schematic cross-sectional representation of a tool of the present invention.

FIGS. 3A-3C provide schematic representations of a tool of the present invention.

FIGS. 4A-4D provide a schematic cross-sectional representation of an embodiment of a method for forming a tool having a continuous, flexible surface having a raised pattern thereon.

FIGS. 5A-5F provide a schematic cross-sectional representation of an embodiment of a method for forming a tool having a continuous, flexible surface having a raised pattern thereon.

FIGS. 6A-6D provide a schematic cross-sectional representation of a pattern on a substrate comprising self-assembled monolayers of varying density.

FIGS. 7A-7F provide a schematic cross-sectional representation of embodiments of the present invention suitable for applying an ink to a continuous, flexible surface of a tool, and distorting the ink pattern.

FIGS. 8A-8C provide exemplary embodiments of a pattern suitable for transferring to a tool, and methods to distort the pattern.

FIGS. 9A-9G provide a schematic cross-sectional representation of an embodiment of the method of the present invention suitable for patterning a substrate.

FIGS. 10A-10D provide a schematic cross-sectional representation of an embodiment of the method of the present invention for patterning a substrate.

FIGS. 11A-11G provide schematic cross-sectional representations of non-planar substrates having surface features thereon that can be prepared by a method of the present invention.

FIG. 12 provides a schematic cross-sectional representation of a curved surface having surface features thereon that can be prepared by a method of the present invention.

FIGS. 13A-13C provide a schematic cross-sectional representation of a method of the present invention suitable for preparing a substrate having a conformal, non-penetrating surface feature thereon.

FIG. 14A provides an image of a planar substrate having a pattern of features thereon. FIG. 14B provides a microscope image of an area of the patterned planar substrate displayed in FIG. 14A.

FIG. 15 provides an image of a tool of the present invention having a continuous, flexible surface having a pattern thereon.

FIG. 16A provides an image of a non-planar substrate having a pattern of features thereon prepared by a method of the present invention. FIGS. 16B and 16C provide microscope images of the patterned non-planar substrate displayed in FIG. 16A.

FIG. 17A provides a microscope image of a patterned non-planar substrate comprising features having defects. FIG. 17B provides an profilometry scan of the patterned non-planar substrate displayed in FIG. 17A.

FIG. 18A provides a microscope image of a patterned non-planar substrate comprising features having defects. FIG. 18B provides an profilometry scan of the patterned non-planar substrate displayed in FIG. 18A.

One or more embodiments of the present invention will now be described with reference to the accompanying drawings. It will be appreciated that for simplicity and clarity of illustration, elements shown in the drawings have not necessarily been drawn to scale. For example, the dimensions of some of the elements are exaggerated relative to each other. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, “some embodiments”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above”, “below”, “up”, “down”, “top”, “bottom,” etc.) made herein are for purposes of description and illustration only, and should be interpreted as non-limiting upon the tools, substrates, coatings, methods, and products of any method of the present invention, which can be spatially arranged in any orientation or manner.

### Non-Planar Substrates

The present invention provides methods for forming a feature in or on a non-planar substrate. Non-planar substrates suitable for use with the present invention are not particularly limited by size, composition or geometry, and include any non-planar material having a surface capable of being contacted with a stamp. A substrate is “non-planar” when any four points lying on the surface of a substrate do not lie in the same plane. Non-planar substrates of the present invention can be curved or faceted, or a combination thereof, including both symmetric and asymmetric non-planar substrates. In some embodiments, a non-planar substrate can include a surface of a spherical, an ellipsoidal, a conical, a cylindrical, a polyhedral, a trigonal pyramidal, or a square pyramidal object, or a combination thereof. The non-planar substrates can be smooth, roughened, pocked, wavy, terraced, and any combination thereof.

A substrate is “curved” when the radius of curvature of a substrate is non-zero over a distance on the surface of about 100 μm or more, or over a distance on the surface of about 1 mm or more. For a curved substrate, a lateral dimension is defined as the magnitude of a segment of the circumference of a circle connecting two points on opposite sides of the surface feature, wherein the circle has a radius equal to the radius of curvature of the substrate. A lateral dimension of a curved substrate having multiple or undulating curvature, or waviness, can be determined by summing the magnitude of segments from multiple circles. In some embodiments, a curved substrate can be patterned using the present invention in combination with a soft lithographic method such as microtransfer molding, mimic, micro-molding, and combinations thereof.

In some embodiments, the non-planar substrate comprises an interior and/or exterior surface of a solid of revolution. As used herein, a “solid of revolution” is a solid figure obtained by rotating a plane figure around some straight line (the axis) that lies on the same plane.

The substrates can be homogeneous or heterogeneous in composition. Substrates suitable for use with the present invention include, but are not limited to, metals, alloys, composites, crystalline materials, amorphous materials, conductors, semiconductors, optics, fibers, inorganic materials, glasses, ceramics (e.g., metal oxides, metal nitrides, metal silicides, and combinations thereof), zeolites, polymers, plastics, organic materials, minerals, biomaterials, living tissue, bone, films thereof, thin films thereof, laminates thereof, foils thereof, composites thereof, and combinations thereof. In some embodiments, a substrate is selected from a porous variant of any of the above materials.

In some embodiments, a substrate comprises a semiconductor such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, and combinations thereof.

In some embodiments, a substrate comprises a glass such as, but not limited to, undoped silica glass (SiO₂), fluorinated silica glass, borosilicate glass, borophosphorosilicate glass, organosilicate glass, porous organosilicate glass, and combinations thereof.

In some embodiments, a non-planar substrate comprises pyrolytic carbon, reinforced carbon-carbon composite, a carbon phenolic resin, and the like, and combinations thereof.

In some embodiments, a substrate comprises a ceramic such as, but not limited to, silicon carbide, hydrogenated silicon carbide, silicon nitride, silicon carbonitride, silicon oxynitride, silicon oxycarbide, high-temperature reusable surface insulation, fibrous refractory composite insulation tiles, toughened unipiece fibrous insulation, low-temperature reusable surface insulation, advanced reusable surface insulation, and combinations thereof.

In some embodiments, a substrate comprises a flexible material, such as, but not limited to: a plastic, a metal, a composite thereof, a laminate thereof, a thin film thereof, a foil thereof, and combinations thereof. In some embodiments, a flexible material can be patterned by the method of the present invention in a reel-to-reel or roll-to-roll manner.

In some embodiments, the methods of the present invention are suitable for patterning the interior surface of a non-planar substrate. For example, the present invention is suitable for forming a pattern of features on the an interior surface of a three-dimensional shape such as a spheroid (e.g., a sphere), a hemisphere, an ellipsoid, a cone, a polyhedron, a cylinder, a toroid, a trigonal pyramid, a square pyramid, and the like.

The present invention is also directed to articles and products prepared by a method of the present invention. Articles and products prepared by a method of the present invention include, but are not limited to, electronic devices, optical windows, mirrors, lenses, antennas, radar domes, nose cones, inlet cones, enclosures for avionics and other electronic equipment, and the like, and combinations thereof.

In some embodiments, the non-planar substrate comprises an interior surface of a nose cone. As used herein, a “nose cone” refers to the forward section of any vehicle designed to travel through a medium (e.g., water, air, space, etc.). Nose cone shapes include, but are not limited to, conical, bi-conic, tangent ogive, secant ogive, elliptical, parabolic, a Haack series shape, and combinations thereof, as well as any other shapes known to persons of ordinary skill in the art. Nose cones having an interior surface patterned by a method of the present invention can be used on or in aircraft, rockets, missiles, spacecraft, satellites, torpedoes, submarines, and the like.

In some embodiments, the non-planar substrate comprises an optical window, lens, or mirror having at least one of: a sensor (e.g., temperature, pressure, etc.) thereon and/or embedded therein, an electric field generator thereon and/or embedded therein, a heating element thereon and/or embedded therein, an antenna (e.g., radiofrequency, very-high frequency, ultra-high frequency, microwave frequency, etc.) thereon and/or embedded therein, a dryer (i.e., an element suitable for removing water or another liquid) thereon and/or embedded therein, a static charge dissipation device thereon and/or embedded therein, and combinations thereof. For example, optical windows having metal lines thereon are useful for electromagnetic shielding applications in analytical tools, aircraft, spacecraft, satellites, and the like.

The present invention is also directed to optimizing the performance, efficiency, cost, and speed of the method steps by selecting inks and substrates that are compatible with one another. For example, in some embodiments, a substrate can be selected based upon its physical properties, optical transmission properties, thermal properties, electrical properties, and combinations thereof.

In some embodiments, a substrate is transparent to at least one type of radiation suitable for initiating a reaction of the ink on the substrate. For example, a substrate transparent to ultraviolet light can be patterned using an ink whose reaction can be initiated by ultraviolet light, thereby permitting reaction of an ink on the front-surface of substrate to be initiated by illuminating a back-surface of the substrate with ultraviolet light.

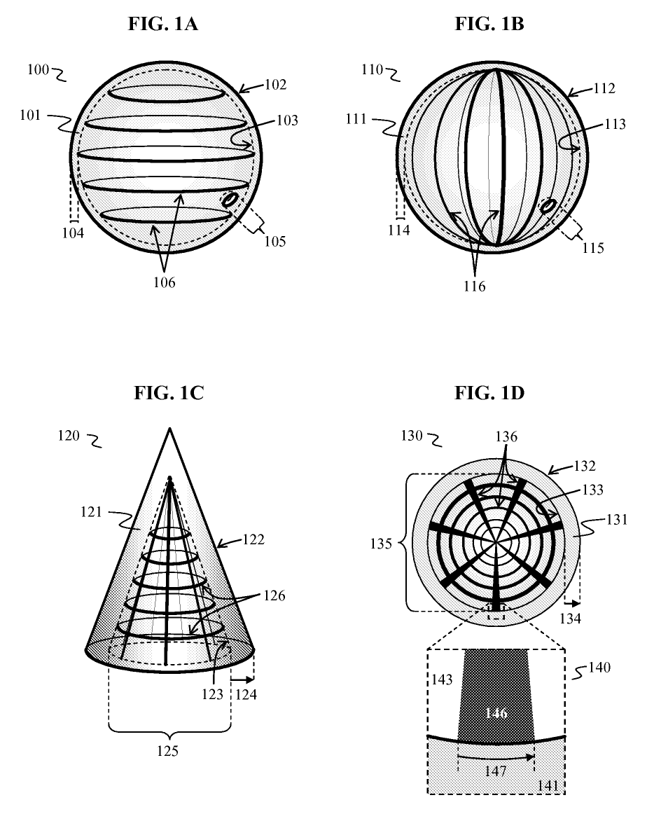

In some embodiments, a non-planar substrate includes an opening therein through which a tool of the present invention can be inserted inside of a non-planar substrate. FIGS. 1A-1D provide three dimensional representations of non-planar substrates having a pattern of features produced by a method of the present invention. Referring to FIG. 1A, a three-dimensional representation, 100, of a non-planar substrate, 101, is provided. The non-planar substrate, 101, has a spherical shape and includes an exterior surface, 102, an interior surface, 103, and has a thickness indicated by the magnitude of line segment 104.

The non-planar substrate further comprises an opening, 105. The inner surface of the non-planar substrate, 103, includes a pattern of features, 106, the features comprising a series of circular parallel lines (e.g., latitudinal lines) on the inner surface of the non-planar substrate.

Referring to FIG. 1B, a three-dimensional representation, 110, of a non-planar substrate, 111, is provided. The non-planar substrate, 111, has a spherical shape and includes an exterior surface, 112, an inner surface, 113, and has a thickness indicated by the magnitude of line segment 114. The non-planar substrate further comprises an opening, 115. The inner surface of the non-planar substrate, 113, includes a pattern of features, 116, the features comprising a series of intersecting circular lines (e.g., longitudinal lines) on the inner surface of the non-planar substrate.

Referring to FIG. 1C, a three-dimensional representation, 120, of a non-planar substrate, 121, is provided. The non-planar substrate, 121, has a conical shape and includes an exterior surface, 122, an interior surface, 123, and has a thickness indicated by the magnitude of vector 124. The non-planar substrate further comprises an opening, 125. The inner surface of the non-planar substrate, 123, includes a pattern of features, 126, the features comprising a grid formed by intersecting vertical and circular lines on the inner surface of the non-planar substrate.

Referring to FIG. 1D, a bottom view of a three-dimensional representation, 130, of a non-planar substrate, 131, is provided. The non-planar substrate, 131, has a conical shape analogous to that provided in FIG. 1C, and includes an exterior surface, 132, an interior surface, 133, and has a thickness indicated by the magnitude of vector 134. The non-planar substrate further comprises an opening, 135. The inner surface of the non-planar substrate, 133, includes a pattern of features, 136, the features comprising a grid formed by intersecting vertical and circular lines on the inner surface of the non-planar substrate. Inset, 140, provides a schematic representation of a feature, 146, on an interior surface, 143, of the non-planar substrate, 141. The feature, 146, has a lateral dimension indicated by the magnitude of vector 147.

### Tools Including a Flexible Surface

The present invention is directed to a method for patterning a non-planar substrate, the method comprising: providing a tool including a continuous, flexible surface having an area, wherein the tool lacks a rigid backing. The continuous, flexible surface of the tool can include any flexible elastomeric material. Elastomeric polymers suitable for use with the present invention include, but are not limited to, polydimethylsiloxane, polysilsesquioxane, polyisoprene, polybutadiene, polychloroprene, acryloxy elastomers, fluorinated and perfluorinated polymers (e.g., polytetrafluoroethylene, perfluoroalkoxy polymer, fluorinate ethylene propylene, and the like), and combinations thereof.

In some embodiments, an elastomeric polymer for use with a tool of the present invention has a Young's Modulus of about 20 MegaPascals (“MPa”) or less, about 15 MPa or less, about 10 MPa or less, about 5 MPa or less, about 3 MPa or less, or about 2 MPa or less. In some embodiments, an elastomeric polymer for use with a tool of the present invention has a Young's Modulus of about 0.1 MPa or more, about 0.2 MPa or more, about 0.3 MPa or more, about 0.5 MPa or more, or about 1 MPa or more. In some embodiments, an elastomeric polymer for use with a tool of the present invention has a Young's Modulus of about 0.1 MPa to about 20 MPa, about 0.2 MPa to about 10 MPa, about 2 MPa to about 4 MPa, about 2.4 MPa, about 2.7 MPa, or about 3.4 MPa.

The thickness of the continuous, flexible surface can be homogeneous or varied. For example, in some embodiments the continuous, flexible surface has at least one indentation therein and/or protrusion thereon, the indentation and/or protrusion being contiguous with and defining a pattern in the surface of the tool. Thus, in some embodiments the surface of the tool can include a topographical pattern (e.g., a raised or an inset pattern).

Patterns on a surface of a tool can also include patterns based upon composition, the surface energy, the compressibility, the porosity, the conductivity, the resistivity, the transparency (i.e., to electromagnetic radiation), the permeability, and combinations thereof. For example, a continuous, flexible surface can be patterned by a treatment step such as, but not limited to, exposure to thermal energy (e.g., a hot-wire or focused infrared radiation), acoustic waves, an oxidizing or reducing plasma, an electron beam, a stoichiometric chemical reagent, a catalytic chemical reagent, an oxidizing or reducing reactive gas, an acid or a base (e.g., a decrease or increase in pH), an increase or decrease in pressure, an alternating or direct electrical current, agitation, sonication, friction, and combinations thereof.

In some embodiments, the continuous, flexible surface is porous. Porous surfaces are frequently permeable to gases and/or liquids, and in some cases are swellable. In some embodiments, the continuous, flexible surface is non-porous. As used herein, “non-porous” refers to surfaces that are generally not permeable to gases, liquids and the like.

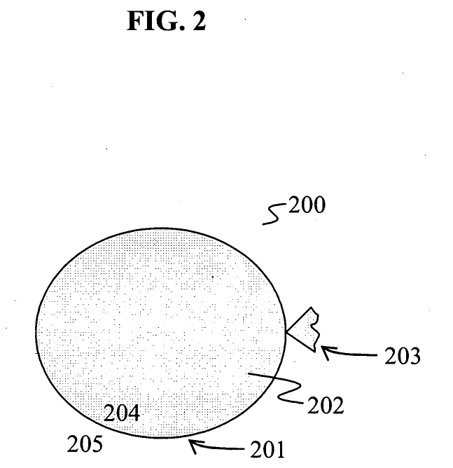

The continuous, flexible surface of the tool can enclose a volume. Referring to FIG. 2, a tool, 200, includes a continuous, flexible surface, 201. In some embodiments, the continuous, flexible surface has a shape comprising at least one of: a spheroid, a hemisphere, an ellipsoid, a cone, a polyhedron, a cylinder, a toroid, a trigonal pyramid, a square pyramid, and combinations thereof. The continuous, flexible surface, 201, encloses a volume, 202. Generally, the volume enclosed by the tool's continuous, flexible surface has a pressure, 204, that is greater than an external pressure, 205.

In some embodiments, the tool further comprises a filling and/or emptying means, 203, that connects an interior volume enclosed by the continuous, flexible surface of the tool with a volume exterior to the tool. In some embodiments, a filling and/or emptying means is an element suitable for increasing and/or decreasing the amount of a material enclosed by the continuous, flexible surface of the tool. Suitable filling and/or emptying means include, but are not limited to, a valve, a pump, a vacuum pump, a mass-flow controller, a permeable membrane, a semi-permeable membrane, and combinations thereof.

A volume enclosed by a continuous, flexible surface of the tool can be filled with a gas (e.g., nitrogen, argon, helium, and the like), a liquid (e.g., water, propylene glycol, mercury, and the like), a solid (e.g., sand), and combinations thereof (e.g., a viscoelastic polymer melt). In some embodiments, a filling and/or emptying means is an element suitable to change the physical state of a material enclosed by the continuous, flexible surface of the tool (e.g., a physical state change can include, but is not limited to, a liquid to gas transition, a liquid to solid transition, a solid to gas transition, combinations thereof, and the reverse thereof). In some embodiments, a filling and/or emptying means can induce a pressure change, a temperature change, or a combination thereof in a material enclosed by the continuous, flexible surface of the tool. Thus, suitable filling and/or emptying means further include, but are not limited to, an electric field generator, a magnet, an electromagnet, a light source, a light valve, a heater, a chiller, and combinations thereof.

The continuous, flexible surface of the tool can be distorted. For example, an area of the continuous, flexible surface of the tool can be distorted by modifying its shape. Additionally, an area and a volume enclosed by the continuous, flexible surface can be distorted by increasing or decreasing the amount of a gas, liquid, or solid within the volume. Thus, the tool has a radius of curvature that is variable and can be controlled.

The tool of the present invention does not include a rigid backing layer adhered to a backside of the continuous, flexible surface of the tool. While a rigid backing layer can be useful to stabilize an elastomeric stamp in most soft lithography methods, in the present invention a rigid backing layer could prevent the tool from undergoing homogeneous distortion. Moreover, the lack of a rigid backing layer can enable the continuous, flexible surface of the tool to conformally contact a wide variety of surfaces having varying contours and shapes, including fully enclosed substrates such as the interior of a sphere and the like.

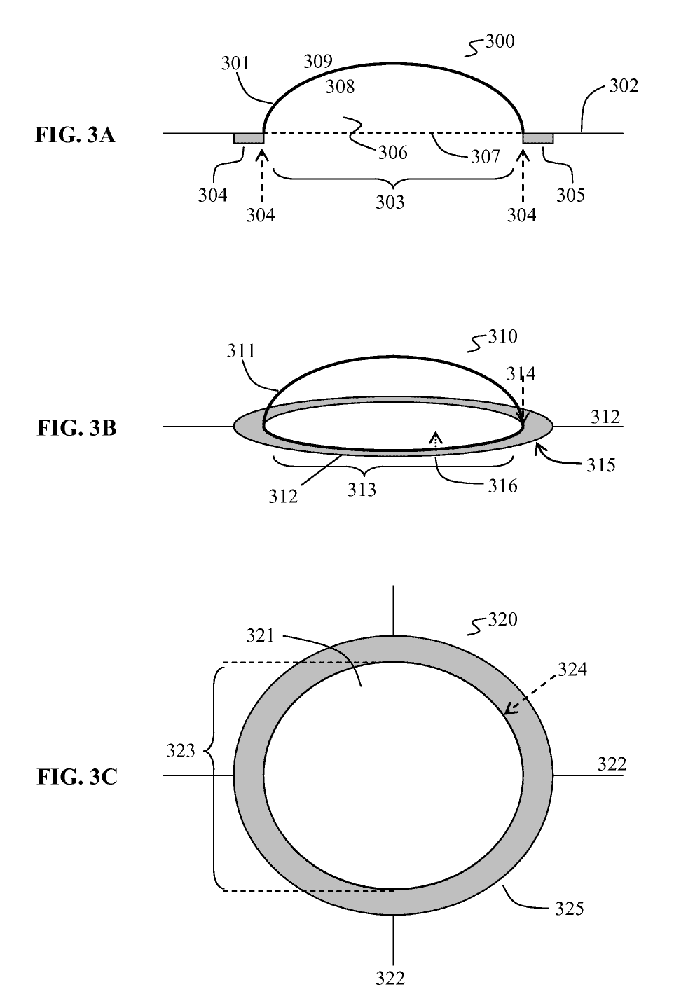

In some embodiments, the tool includes a continuous, flexible surface that is formed over an opening around which an edge of the continuous, flexible surface is restrained. FIGS. 3A-3C provide three different views of a schematic diagram of a tool of the present invention that includes a continuous, flexible surface formed over an opening. Referring to FIG. 3A, depicted is a schematic cross-sectional representation of a tool, 300, of the present invention, the tool including a continuous, flexible surface, 301, over an opening, 303, in a second surface, 302. The second surface, 302, can be planar or non-planar. The opening includes an edge, 304, that forms the opening and at which the continuous, flexible surface of the tool can be restrained. In some embodiments, the edge, 304, further includes a collar, 305, suitable for restraining an edge of the continuous, flexible surface. The collar depicted in FIGS. 3A-3C is by way of example only and not limitation, and any optional retaining means suitable for attaching the continuous, flexible surface to the second surface is suitable for use with the present invention. Suitable optional retaining means include, but are not limited to, a collar, an adhesive, an epoxy, a ring, a gasket, a magnetic interaction, gravity, a vacuum, an electrostatic interaction, and combinations thereof. The tool's continuous, flexible surface encloses a volume, 306. Referring to FIG. 3A, the enclosed volume, 306, is that which is between the continuous, flexible surface and a plane, 307, that is co-planar with the second surface, 302. In embodiments in which the second surface, 302, is curved, the enclosed volume is that which is between the continuous, flexible surface, 301, and a curved surface having the same radius of curvature as the second surface, 302. The enclosed volume, 306, has a pressure, 3086, that is greater than an external pressure, 309. The convex shape of the continuous, flexible surface depicted in FIG. 3A is by way of example only and not limitation, and the present invention is also directed to similar continuous, flexible surfaces having a concave shape (i.e., the continuous, flexible surface, 301, lies below the plane or curvature of the second surface, 302).

Referring to FIG. 3B, depicted is a three-dimensional view of the tool, 310, having a continuous, flexible surface, 311. The continuous, flexible surface covers an opening, 313, in a second surface, 312, defined by an edge, 314. In some embodiments, an optional retaining means, 315, is set into and/or on the second surface and can function to maintain the position of the continuous, flexible membrane. The tool, 310, includes a volume enclosed by the continuous, flexible surface, 316.

Referring to FIG. 3C, depicted is a top-view (i.e., looking down) of a tool, 320, having a continuous, flexible surface, 321. The continuous, flexible surface is over an opening, 323, in a second surface, 322, having an edge, 324. In some embodiments, the edge of the second surface, 324, is also the edge of the continuous, flexible surface of the tool. In some embodiments, the continuous flexible surface, 321, is restrained by an optional restraining means, 325, set into and/or on the second surface, 322.

In some embodiments, the continuous, flexible surface of the tool is coated with a second material such as, but not limited to, a metal, a chemical monolayer, a polymer, and combinations thereof. Such a coating can be uniform or applied in a pattern. For example, a continuous, flexible surface comprising latex can be covered by a layer of polydimethylsiloxane (PDMS), wherein the PDMS is of uniform or varying thickness, and in some embodiments can have at least one indentation therein forming a pattern. Methods of forming a layer on the continuous, flexible surface, but are not limited to, micromolding, electroplating, ink-jet depositing, shadow-mask depositing, and combinations thereof.

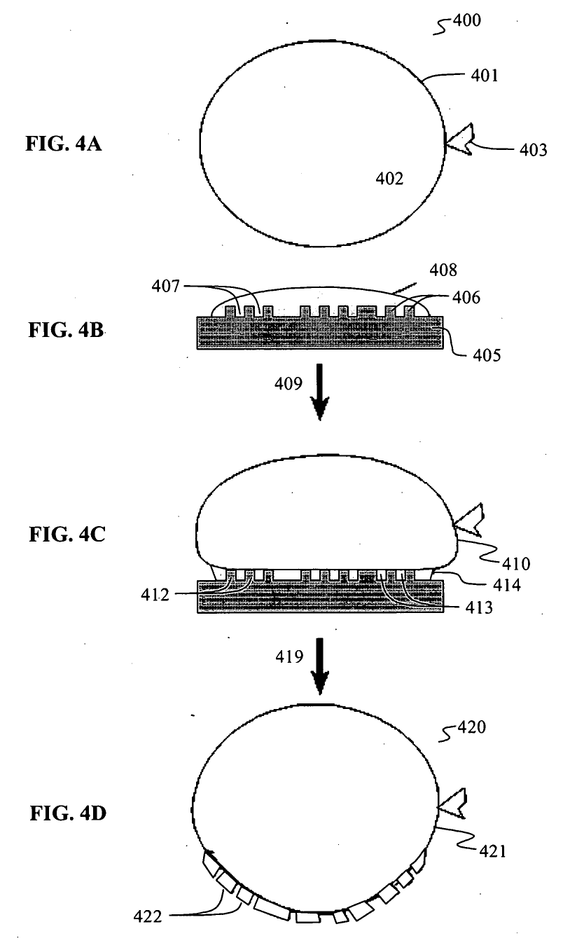

FIGS. 4A-4D provide a schematic, cross-sectional representation of a method for forming a pattern on the continuous, flexible surface of the tool. Referring to FIG. 4A, a tool, 400, is provided having a continuous, flexible surface, 401, enclosing a volume, 402, and having a filling and/or emptying means, 403. Referring to FIG. 4B, further provided is a stamp, 405, having a surface, 406, including at least one indentation therein, 407. A precursor, 408, is disposed on the stamp surface. The continuous, flexible surface of the tool is contacted, 409, with the stamp surface to provide the configuration depicted in FIG. 4C, in which the tool's continuous, flexible surface, 410, is distorted by contacting the stamp surface, 412. The at least one indentation in the stamp surface, 413, is filled by the precursor, 414. The tool and stamp are then removed from one another, 419. Referring to FIG. 4D, the tool, 400, includes a continuous, flexible surface, 421, having a raised pattern thereon, 422. The method depicted in FIG. 4A-4D can further include a reacting step, wherein the precursor is reacted and/or cured to provide a solid pattern on the continuous, flexible surface of the tool. A reacting step can be performed either while the stamp surface and tool are in contact (FIG. 4C) or after removing the tool from the stamp surface (FIG. 4D).

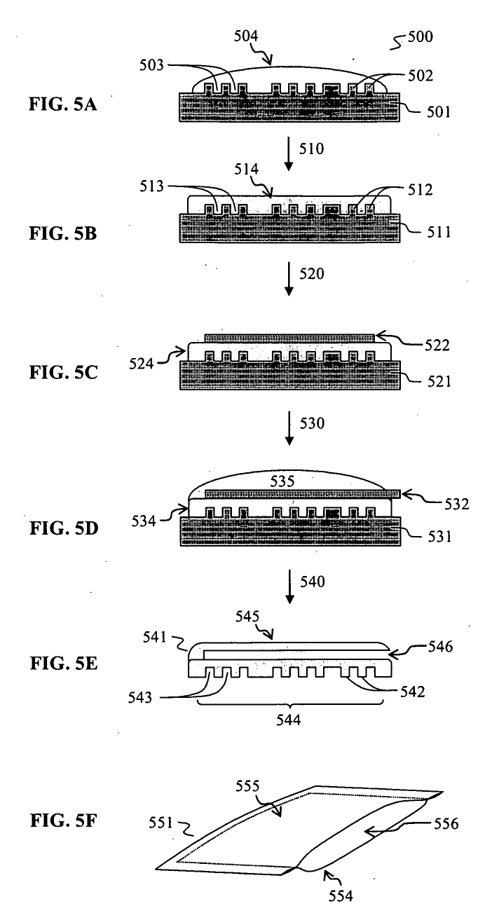

FIGS. 5A-5F provide a schematic representation of a method for forming a tool of the present invention having a continuous, flexible surface. FIG. 5A provides a diagram, 500, showing a master, 501, having a surface, 502. Referring to FIG. 5A, included on the surface are optional protrusions, 503, that define a pattern, 504, on the surface of the master. An elastomeric precursor, 505, has been applied to the optionally patterned surface of the master, 502. The elastomeric precursor, 505, is then reacted, 510, to provide a flexible surface.

Referring to FIG. 5B, an elastomer, 515, is provided on the surface, 512, of the master, 511. The elastomer, 515, includes an optional pattern of indentations, 513, corresponding to the pattern in the surface of the master. The elastomer, 515, can be optionally separated from the master or remain in contact with the master during the subsequent steps of the method. A spacer is then applied to the elastomer, 520.

Referring to FIG. 5C, depicted is an optional master, 521, having an elastomer, 535, thereon, and a spacer, 526, on the elastomer. The spacer, 526, can be prepared from a material that does not substantially interact (e.g., via a bonding and/or non-bonding interaction) with an elastomer and/or an elastomeric precursor. Exemplary non-limiting materials suitable for use as a spacer include polytetrafluoroethylene, perfluoroalkoxy polymer, fluorinate ethylene propylene, and the like. An elastomeric precursor is than applied to the spacer and the elastomer, 530.

Referring to FIG. 5D, depicted is an optional master, 531, having an elastomer, 535, a spacer, 536, and an elastomeric precursor, 537, thereon. A portion of the spacer, 536, protrudes, 538, from the elastomer and elastomeric precursor. The elastomeric precursor is then reacted to form an elastomer, the spacer is removed, and the resulting tool is separated from the master, 540.

FIGS. 5E and 5F provide a cross-sectional schematic representation and a three-dimensional schematic representation, respectively, of a tool of the present invention having a continuous flexible surface. Referring to FIG. 5E, a tool, 541, includes a continuous, flexible surface, 542, optionally having one or more indentations, 543, therein, the indentations defining a pattern, 544, in the surface of the tool. The tool further includes an opening, 546, in the continuous, flexible surface that is suitable to fill or empty a volume, 547, enclosed by the continuous, flexible surface. The area of the continuous, flexible surface can be controlled and modified for example, by filling or emptying the volume, 547, via the opening, 546. The opening, 546, can optionally include one or more control elements suitable for controlling the concentration, temperature, and or pressure of a substance contained within the volume of the tool.

Referring to FIG. 5F, a three-dimensional schematic representation of a tool, 551, of the present invention is provided. The tool, 551, includes a continuous, flexible surface, 552, optionally including a pattern on at least a portion of the surface. A pattern can comprise protrusions and/or indentations in the surface of the tool. The tool depicted in FIG. 5F further comprises an opening, 556, that is connected to an internal volume of the tool, 557. A pattern on the surface of the tool can be distorted by filling or emptying the volume of the tool, 557, via the opening, 556.

### Inks

As used herein, an “ink” refers to a composition suitable for applying to a substrate using the continuous, flexible surface of the tool. Alternatively, an ink can be applied to a non-planar substrate and a tool of the present invention having a raised pattern thereon can be applied to the ink-coated non-planar substrate to form an ink pattern thereon. Inks suitable for use with the present invention include both homogeneous and heterogeneous compositions, the latter referring to a composition having more than one component. Inks can be liquids, solids, semi-solids, and the like. Inks suitable for use with the present invention include, but are not limited to, molecular solutions, polymer solutions, pastes, gels, creams, glues, resins, epoxies, adhesives, metal films, particulates, solders, etchants, and combinations thereof.

Inks can include materials such as, but not limited to, monolayer-forming species, thin film-forming species, oils, colloids, metals, metal complexes, metal oxides, ceramics, organic species (e.g., moieties comprising a carbon-carbon bond, such as small molecules, polymers, polymer precursors, proteins, antibodies, and the like), polymers (e.g., both non-biological polymers and biological polymers such as single and double stranded DNA, RNA, and the like), polymer precursors, dendrimers, nanoparticles, and combinations thereof. In some embodiments, one or more components of an ink includes a functional group suitable for associating with a substrate, for example, by forming a chemical bond, by an ionic interaction, by a Van der Waals interaction, by an electrostatic interaction, by magnetism, by adhesion, and combinations thereof.

In some embodiments, the composition of an ink can be formulated to control its viscosity. Parameters that can control ink viscosity include, but are not limited to, solvent composition, solvent concentration, thickener composition, thickener concentration, particles size of a component, the molecular weight of a polymeric component, the degree of cross-linking of a polymeric component, the free volume (i.e., porosity) of a component, the swellability of a component, ionic interactions between ink components (e.g., solvent-thickener interactions), and combinations thereof.

In some embodiments, the ink has a tunable viscosity, and/or a viscosity that can be controlled by one or more external conditions. In some embodiments, an ink has a viscosity of about 0.1 cP to about 10,000 cP, about 0.1 cP to about 8,000 cP, about 0.1 cP to about 5,000 cP, about 0.1 cP to about 2,000 cP, about 0.1 cP to about 1,000 cP, about 0.1 cP to about 500 cP, about 0.1 cP to about 100 cP, about 0.1 cP to about 80 cP, about 0.1 cP to about 50 cP, about 0.1 cP to about 20 cP, about 0.1 cP to about 10 cP, about 10 cP to about 10,000 cP, about 10 cP to about 8,000 cP, about 10 cP to about 5,000 cP, about 10 cP to about 2,000 cP, about 10 cP to about 1,000 cP, about 10 cP to about 500 cP, about 10 cP to about 100 cP, about 10 cP to about 80 cP, about 10 cP to about 50 cP, about 10 cP to about 20 cP, about 100 cP to about 10,000 cP, about 100 cP to about 8,000 cP, about 100 cP to about 5,000 cP, about 100 cP to about 2,000 cP, about 100 cP to about 1,000 cP, about 100 cP to about 500 cP, about 500 cP to about 10,000 cP, about 500 cP to about 8,000 cP, about 500 cP to about 5,000 cP, about 500 cP to about 2,000 cP, about 500 cP to about 1,000 cP, about 1,000 cP to about 10,000 cP, about 1,000 cP to about 8,000 cP, about 1,000 cP to about 5,000 cP, about 1,000 cP to about 2,000 cP, about 2,000 cP to about 10,000 cP, about 2,000 cP to about 8,000 cP, or about 5,000 cP to about 10,000 cP, and the like.

Not being bound by any particular theory, as the lateral dimensions of surface features to be formed by the method of the present invention decrease, the viscosity of an ink used to form the pattern can be decreased.

In some embodiments, the viscosity of an ink is modified during one or more of an applying step, a contacting step, a reacting step, or a combination thereof. For example, the viscosity of an ink can be decreased while applying an ink to the surface of a stamp to ensure that indentations in the surface of a stamp are substantially filled in a uniform manner. After contacting a coated stamp with a non-planar substrate, the viscosity of an ink can be increased to ensure that the lateral dimensions of the indentations in the stamp are transferred to the lateral dimensions of a feature formed on the surface of the non-planar substrate.

Not being bound by any particular theory, the viscosity of an ink can be controlled by an external stimulus such as temperature, pressure, pH, the presence or absence of a reactive species, electromagnetic radiation, electrical current, a magnetic field, and combinations thereof. For example, increasing the temperature of an ink will typically decrease its viscosity. Moreover, increasing the pressure applied to an ink will typically increase its viscosity.

The viscosity of an ink can either increase or decrease with a change in pH depending on the properties of one or more components in the ink, and depending on the overall solubility of the ink as a function of pH. For example, an aqueous ink containing a weakly acidic polymer will typically have a decreased viscosity below the pKₐ of the polymer because the solubility of the polymer will increase below its pKₐ. However, if protonation of the polymer leads to an ionic interaction between the polymer and another component in the ink that decreases the solubility of the polymer, then the viscosity of the ink will likely increase. Careful selection of ink components permits ink viscosity to be controlled over a wide range of pH values.

In some embodiments, the ink comprises a solvent, a thickening agent, an ionic species (e.g., a cation, an anion, a zwitterion, etc.) the concentration of which can be selected to adjust one or more of the viscosity, the dielectric constant, the conductivity, the tonicity, the density, and the like. Not being bound by any particular theory, the viscosity and/or density of an ink can be an important parameter for producing surface features having a lateral dimension of about 40 nm to about 100 μm.

Suitable thickening agents include, but are not limited to, metal salts of carboxyalkylcellulose derivatives (e.g., sodium carboxymethylcellulose), alkylcellulose derivatives (e.g., methylcellulose and ethylcellulose), partially oxidized alkylcellulose derivatives (e.g., hydroxyethylcellulose, hydroxypropylcellulose and hydroxypropylmethylcellulose), starches, polyacrylamide gels, homopolymers of poly-N-vinylpyrrolidone, poly(alkyl ethers) (e.g., polyethylene oxide and polypropylene oxide), agar, agarose, xanthan gums, gelatin, dendrimers, colloidal silicon dioxide, and combinations thereof. In some embodiments, a thickener is present in a concentration of about 0.5% to about 25%, about 1% to about 20%, or about 5% to about 15% by weight of an ink.

In some embodiments, as the lateral dimensions of the desired surface features decrease it is necessary to reduce the particle size or physical length of components in the ink. For example, for surface features having a lateral dimension of about 100 nm or less it can be necessary to reduce or eliminate polymeric components from an ink composition.

Suitable solvents for use with an ink of the present invention include, but are not limited to, water, C₁-C₈ alcohols (e.g., methanol, ethanol, propanol and butanol), C₆-C₁₂ straight chain, branched and cyclic hydrocarbons (e.g., hexane and cyclohexane), C₆-C₁₄ aryl and aralkyl hydrocarbons (e.g., benzene and toluene), C₃-C₁₀ alkyl ketones (e.g., acetone), C₃-C₁₀ esters (e.g., ethyl acetate), C₄-C₁₀ alkyl ethers, and combinations thereof. In some embodiments, a solvent is present in a concentration of about 1% to about 99%, about 5% to about 95%, about 10% to about 90%, about 15% to about 95%, about 25% to about 95%, about 50% to about 95%, or about 75% to about 95% by weight of an ink.

In some embodiments, an ink comprises an etchant. As used herein, an “etchant” refers to a component that can react with a surface to remove a portion of the surface. Thus, an etchant is used to form a subtractive feature by reacting with a surface and forming at least one of a volatile and/or soluble material that can be removed from the substrate, or a residue, particulate, or fragment that can be removed from the substrate by, for example, a rinsing or cleaning method. In some embodiments, an etchant is present in a concentration of about 0.5% to about 95%, about 1% to about 90%, about 2% to about 85%, about 0.5% to about 10%, or about 1% to about 10% by weight of the ink.

Etchants suitable for use with the present invention either as an ink, or for reacting with an area of a substrate not covered by a masking pattern, include, but are not limited to, an acidic etchant, a basic etchant, a fluoride-based etchant, and combinations thereof. Acidic etchants suitable for use with the present invention include, but are not limited to, sulfuric acid, trifluoromethanesulfonic acid, fluorosulfonic acid, trifluoroacetic acid, hydrofluoric acid, hydrochloric acid, carborane acid, and combinations thereof. Basic etchants suitable for use with the present invention include, but are not limited to, sodium hydroxide, potassium hydroxide, ammonium hydroxide, tetraalkylammonium hydroxide ammonia, ethanolamine, ethylenediamine, and combinations thereof. Fluoride-based etchants suitable for use with the present invention include, but are not limited to, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof.

In some embodiments, the ink includes a reactive component. As used herein, a “reactive component” refers to a compound or species that has a chemical interaction with a substrate. In some embodiments, a reactive component in the ink penetrates or diffuses into the substrate. In some embodiments, a reactive component transforms, binds, or promotes binding to exposed functional groups on the surface of the substrate. Reactive components can include, but are not limited to, ions, free radicals, metals, acids, bases, metal salts, organic reagents, and combinations thereof. Reactive components further include, without limitation, monolayer-forming species such as thiols, hydroxides, amines, silanols, siloxanes, and the like, and other monolayer-forming species known to a person or ordinary skill in the art.

In some embodiments, a reactive component is present in a concentration of about 0.001% to about 100%, about 0.001% to about 50%, about 0.001% to about 25%, about 0.001% to about 10%, about 0.001% to about 5%, about 0.001% to about 2%, about 0.001% to about 1%, about 0.001% to about 0.5%, about 0.001% to about 0.05%, about 0.01% to about 10%, about 0.01% to about 5%, about 0.01% to about 2%, about 0.01% to about 1%, about 10% to about 100%, about 50% to about 99%, about 70% to about 95%, about 80% to about 99%, about 0.001%, about 0.005%, about 0.01%, about 0.1%, about 0.5%, about 1%, about 2%, or about 5% weight of the ink.

In some embodiments, the ink further comprises a conductive and/or semi-conductive component. As used herein, a “conductive component” refers to a compound or species that can transfer or move electrical charge. Conductive and semi-conductive components include, but are not limited to, a metal, a nanoparticle, a polymer, a cream solder, a resin, and combinations thereof. In some embodiments, a conductive component is present in a concentration of about 1% to about 100%, about 1% to about 10%, about 5% to about 100%, about 25% to about 100%, about 50% to about 100%, about 75% to about 99%, about 2%, about 5%, about 90%, about 95% by weight of the ink.

Metals suitable for use in an ink include, but are not limited to, a transition metal, aluminum, silicon, phosphorous, gallium, germanium, indium, tin, antimony, lead, bismuth, alloys thereof, and combinations thereof. In some embodiments, a metal is present as a nanoparticle (e.g., a particle having a diameter of 100 nm or less, or about 0.5 nm to about 100 nm). Nanoparticles suitable for use with the present invention can be homogeneous, multilayered, functionalized, and combinations thereof.

In some embodiments, an ink comprises a semi-conductive polymer. Semi-conductive polymers suitable for use with the present invention include, but are not limited to, a polyaniline, a poly(3,4-ethylenedioxythiophene)-poly(styrenesulfonate), a polypyrrole, an arylene vinylene polymer, a polyphenylenevinylene, a polyacetylene, a polythiophene, a polyimidazole, and combinations thereof.

In some embodiments, the ink includes an insulating component. As used herein, an “insulating component” refers to a compound or species that is resistant to the movement or transfer of electrical charge. In some embodiments, an insulating component has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulating components suitable for use with the present invention include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, a polyimide, and combinations thereof. In some embodiments, for example, an insulating component is present in a concentration of about 1% to about 95%, about 1% to about 80%, about 1% to about 50%, about 1% to about 20%, about 1% to about 10%, about 20% to about 95%, about 20% to about 90%, about 40% to about 80%, about 1%, about 5%, about 10%, about 90%, or about 95% by weight of the ink.

In some embodiments, the ink includes a masking component. As used herein, a “masking component” refers to a compound or species that upon reacting forms a surface feature resistant to a species capable of reacting with the surrounding surface. Masking components suitable for use with the present invention include materials commonly employed in traditional photolithography methods as “resists” (e.g., photoresists, chemical resists, self-assembled monolayers, etc.). Masking components suitable for use with the present invention include, but are not limited to, a polymer such as a polyvinylpyrollidone, poly(epichlorohydrin-co-ethyleneoxide), a polystyrene, a poly(styrene-co-butadiene), a poly(4-vinylpyridine-co-styrene), an amine terminated poly(styrene-co-butadiene), a poly(acrylonitrile-co-butadiene), a styrene-butadiene-styrene block copolymer, a styrene-ethylene-butylene block linear copolymer, a polystyrene-block-poly(ethylene-ran-butylene)-block-polystyrene, a poly(styrene-co-maleic anhydride), a polystyrene-block-poly(ethylene-ran-butylene)-block-polystyrene-graft-maleic anhydride, a polystyrene-block-polyisoprene-block-polystyrene, a polystyrene-block-poly(ethylene-ran-butylene)-block-polystyrene, a polynorbornene, a dicarboxy terminated poly(acrylonitrile-co-butadiene-co-acrylic acid), a dicarboxy terminated poly(acrylonitrile-co-butadiene), a polyethyleneimine, a poly(carbonate urethane), a poly(acrylonitrile-co-butadiene-co-styrene), a poly(vinylchloride), a poly(acrylic acid), a poly(methylmethacrylate), a poly(methyl methacrylate-co-methacrylic acid), a polyisoprene, a poly(1,4-butylene terephthalate), a polypropylene, a poly(vinyl alcohol), a poly(1,4-phenylene sulfide), a polylimonene, a poly(vinylalcohol-co-ethylene), a poly[N,N′-(1,3-phenylene)isophthalamide], a poly(1,4-phenylene ether-ether-sulfone), a poly(ethyleneoxide), a poly[butylene terephthalate-co-poly(alkylene glycol) terephthalate], a poly(ethylene glycol) diacrylate, a poly(4-vinylpyridine), a poly(DL-lactide), a poly(3,3′,4,4′-benzophenonetetracarboxylic dianhydride-co-4,4′-oxydianiline/1,3-phenylenediamine), an agarose, a polyvinylidene fluoride homopolymer, a styrene butadiene copolymer, a phenolic resin, a ketone resin, a 4,5-difluoro-2,2-bis(trifluoromethyl)-1,3-dioxane, a salt thereof, and combinations thereof. In some embodiments, a masking component is present in a concentration of about 1% to about 10%, about 1% to about 5%, or about 2% by weight of the ink.

In some embodiments, the ink includes a conductive component and a reactive component. For example, a reactive component present in the ink can promote at least one of: penetration of a conductive component into a surface, reaction between the conductive component and a surface, adhesion between a conductive feature and a surface, promoting electrical contact between a conductive feature and a surface, and combinations thereof. Surface features formed by reacting this ink composition include conductive features selected from the group consisting of: additive non-penetrating, additive penetrating, subtractive penetrating, and conformal penetrating surface features.

In some embodiments, the ink comprises an etchant and a conductive component, for example, suitable for producing a subtractive surface feature having a conductive feature inset therein.

In some embodiments, the ink comprises an insulating component and a reactive component. For example, a reactive component present in the ink can promote at least one of: penetration of an insulating component into a surface, reaction between the insulating component and a surface, adhesion between an insulating feature and a surface, promoting electrical contact between an insulating feature and a surface, and combinations thereof. Surface features formed by reacting this ink composition include insulating features selected from the group consisting of: additive non-penetrating, additive penetrating, subtractive penetrating, and conformal penetrating surface features.

In some embodiments, the ink comprises an etchant and an insulating component, for example, suitable for producing a subtractive surface feature having an insulating feature inset therein.

In some embodiments, the ink comprises a conductive component and a masking component, for example, suitable for producing electrically conductive masking features on a surface.

### Applying the Ink, Distorting, and Patterning

In some embodiments, the method of the present invention comprises: applying an ink to at least a portion of the continuous, flexible surface of the tool to form an ink pattern thereon. Thus, the present invention is directed to methods of microcontact printing on non-planar substrates using a tool having a continuous, flexible surface.

In some embodiments, the method of the present invention comprises: applying an ink to at least a portion of a planar or non-planar substrate and contacting a tool having a continuous, flexible surface including at least one indentation therein with the inked substrate. Thus, the present invention is directed to methods of micromolding on planar or non-planar substrates using a tool having a continuous, flexible surface including at least one indentation, channel, or groove therein, wherein a pattern formed on a planar or non-planar substrate corresponds to the patter of indentations, grooves, and channels on the continuous, flexible surface of the tool.

Not being bound by any particular theory, the advantages of the present invention include the ability to form distortion-free patterns on non-planar substrates using a contact printing method. The methods of the present invention are particularly advantageous for substrates having irregular geometry, asymmetry, surface roughness and waviness, and any other characteristics that make the substrates unsuitable for patterning using a flat stamp.

Inks can be applied to a stamp surface and/or a substrate by methods known in the art such as, but not limited to, screen printing, ink jet printing, syringe deposition, spraying, spin coating, brushing, contact printing, dip-coating, molding, micro-transfer molding, stenciling, magnetically affixing, electrostatically affixing, and combinations thereof. In some embodiments, an ink is applied at a uniform thickness. However, the ink need not be of uniform thickness, and in some embodiments, can form a pattern on the substrate.

In some embodiments, the applying comprises a contacting method such as, but not limited to, contacting an ink reservoir or an ink pad with a surface and/or substrate. An ink pad and/or ink reservoir can refer to a planar or non-planar surface containing an ink, that transfers at least a portion of the ink to a surface upon contact. Contacting can include physically contacting, conformally contacting, contacting under applied pressure, contacting while distorting a surface and or substrate, and combinations thereof. materials for use as an ink pads include, but are not limited to, a metal, an inorganic material (e.g., a silicon wafer), a polymer (e.g., a stamp), an oxide, a textured substrate, and the like, and combinations thereof.

In some embodiments, an ink pad includes at least one of a topographical relief pattern, a chemically functionalized pattern, or a uniform surface with a means for forming an ink pattern thereon.

In some embodiments, the ink is applied to the tool using a stamp. As used herein, a “stamp” refers to a three-dimensional object having surface. Stamps for use with the present invention are not particularly limited by geometry, and can be flat, curved, smooth, rough, wavy, and combinations thereof. In some embodiments, a stamp can have a three dimensional shape suitable for conformally contacting the tool. In some embodiments, a stamp includes a surface having at least one indentation therein. In some embodiments, a stamp can comprise multiple patterned surfaces that comprise the same, or different patterns. In some embodiments, a stamp comprises a cylinder wherein one or more indentations in the curved face of the cylinder define a pattern. As the cylindrical stamp is rolled across the tool, the pattern is repeated. Ink can be applied to a cylindrical stamp as it rotates. For stamps having multiple patterned surfaces: cleaning, applying, contacting, removing, and reacting steps can occur simultaneously on the different surfaces of the same stamp.

Stamps for use with the present invention are not particularly limited by materials, and can be prepared from materials such as, but not limited to, glass (e.g., quartz, sapphire, borosilicate glass), ceramics (e.g., metal carbides, metal nitrides, metal oxides), plastics, metals, and combinations thereof. In some embodiments, a stamp for use with the present invention comprises an elastomeric polymer.

In some embodiments, applying an ink comprises contacting the continuous, flexible surface of the tool with an stamp having a surface including at least one indentation therein, the indentation and opening being contiguous with and defining a pattern in the surface of the stamp. As used herein, a “stamp” refers to a three-dimensional object having a surface including at least one indentation therein, the indentation defining a pattern in the stamp surface suitable for transferring an ink from either the surface or an indentation to a tool of the present invention.

In some embodiments, applying an ink comprises contacting the continuous, flexible surface of the tool with an elastomeric stencil having a surface including at least one opening there through, the opening being contiguous with and defining a pattern in the surface of the elastomeric stencil. As used herein, a “stencil” refers to a three-dimensional object having a surface including at least one opening that penetrates through two opposite surfaces of the stencil to form an opening in the surface of the three-dimensional object, the opening defining a pattern in the surface of the three-dimensional object suitable for applying an ink to a tool of the present invention.

The stamps and stencils for use with the present invention (e.g., to apply an ink pattern to a tool of the present invention) are not particularly limited by geometry, and can be flat, curved, smooth, rough, wavy, and combinations thereof.

In some embodiments, a stamp or stencil comprises a flexible material such as an elastomer. Generally, stamps and stencils comprising an elastomer are referred to as elastomeric stamps and elastomeric stencils, respectively. In some embodiments, an elastomeric stamp or elastomeric stencil further comprises a stiff, flexible, porous, or woven backing material, or any other means of preventing deformation of a stamp or a stencil during it is used during the ink application methods described herein.

In some embodiments, an ink is poured onto a surface of a stamp or a stencil, and a blade is then moved transversely across the surface of the stamp or the stencil to ensure that the indentations or openings in the stamp or stencil are filled with the ink. The blade can also remove excess ink from the surface of a stamp or a stencil. A tool is then contacted with the inked stamp or the inked stencil, and the ink pattern is transferred to the tool surface in a pattern according to the indentations or openings in the stamp or stencil, respectively.

In some embodiments, an ink can be applied to a surface (e.g., a substrate, a stamp surface, a stencil surface, or a continuous, flexible surface of a tool) by a spin-coating method comprising applying an ink to a surface while rotating the surface at about 100 revolutions per minute (“rpm”) to about 5,000 rpm, or about 1,000 rpm to about 3,000 rpm, while pouring, flowing, spraying, or otherwise depositing the ink onto the rotating surface.

In some embodiments, the continuous, flexible surface of the tool is distorted during the applying, after the applying, during the contacting, and combinations thereof. Distorting the continuous, flexible surface modifies at least one of the pattern size, pattern density, pattern shape, and combinations thereof. Distorting can include, but is not limited to, increasing the volume enclosed by the continuous, flexible surface (e.g., by increasing the internal pressure of the tool), decreasing the volume enclosed by the continuous, flexible surface (e.g., by decreasing the internal pressure of the tool), applying homogeneous pressure to the continuous, flexible surface, contacting the tool with a substrate, and combinations thereof.

In some embodiments, the distorting can provide an efficient means to provide a pattern comprising a closely-packed self-assembled monolayer on a substrate. A common problem for depositing patterns comprising SAMs is that errors can occur during any of: the applying of a SAM-forming species to a stamp, the transferring of a SAM-forming species from a stamp to a tool, or the transferring of a SAM-forming species from a tool to a substrate, wherein an error can produce a defect in a feature or pattern on a substrate. Such defects are frequently due to a SAM having a density that is less than the density of a closely packed SAM. As referred to, this can arise when the ink density on a stamp is not sufficient to transfer enough ink to a substrate to form a closely packed SAM.

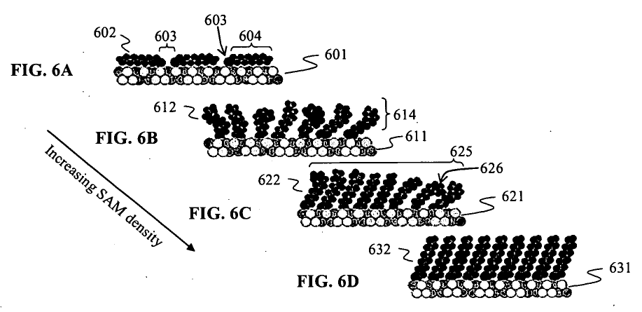

FIGS. 6A-6D depict a schematic cross-sectional representation of a substrate having a pattern thereon, wherein the pattern comprises a SAM, and depict graphically the effect of density on SAM formation. Referring to FIG. 6A, a substrate, 601, is patterned with a SAM-forming species, 602, including a functional group, 603, suitable for binding to the substrate. In FIG. 6A, the surface density of the SAM-forming species, 602, is low, such that the SAM-forming species having a linear chain, 604, can lie flat on the surface. Referring to FIG. 6B, the density of the SAM-forming species, 612, on the substrate, 611, is increased compared to FIG. 6A. However, the density of the SAM-forming species on the substrate is still sufficiently low to permit considerable freedom of movement in the linear chain of the SAM-forming species, 614. Referring to FIG. 6C, the density of the SAM-forming species, 622, on the substrate, 621, is sufficiently high that there is little freedom of movement in the SAM, 625. However, at the density depicted schematically in FIG. 6C, point defects, 626, and the like can form in the SAM. Referring to FIG. 6D, the density of the SAM-forming species, 632, on the substrate, 631, is close-packed, which means there are no unoccupied sites on the surface, and the SAM-forming species aligns in a regular or semi-regular configuration on the substrate. In some embodiments, the present invention provides a method for forming patterns comprising closely packed SAMs, as depicted in FIG. 6D, on curved and/or non-planar substrates.

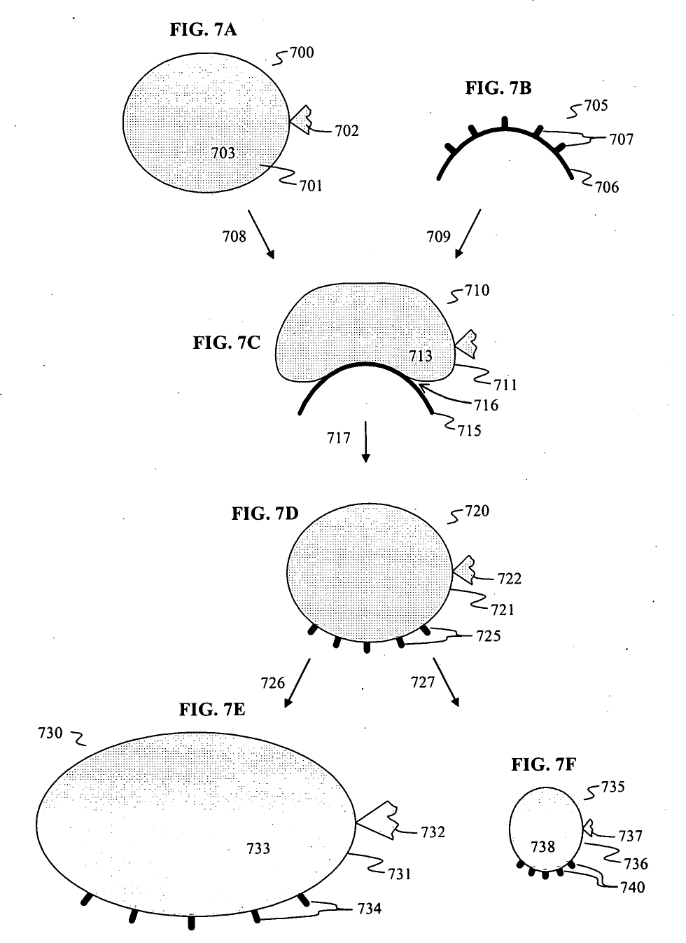

FIGS. 7A-7F depict a schematic cross-sectional representation of an embodiment of the method of the present invention suitable for applying an ink to the continuous, flexible surface of a tool, and distorting the ink pattern thereon. Referring to FIG. 7A, a tool, 700, including a continuous, flexible surface, 701, enclosing a volume, 703, is provided. In some embodiments, the tool further comprises a filling and/or emptying means, 702, suitable for increasing and/or decreasing the internal pressure of the tool and/or modifying the volume enclosed by the tool's surface.

Referring to FIG. 7B, also provided is an applying means, 705, comprising a curved surface, 706, having an ink pattern thereon, 707. The tool is then contacted with the applying means, 708, or the applying means is contacted with the tool, 709, resulting in the configuration depicted in FIG. 7C. The tool's continuous, flexible surface, 711, has been distorted by the contacting the applying means, 715. In some embodiments, the tool and the applying means are conformally contacted with one another, 716. The volume enclosed by the tool, 713, has not changed compared to FIG. 7A. The tool and the applying means are contacted for an amount of time sufficient to transfer the ink pattern from the applying means to the tool, and then they are separated, 717.

Referring to FIG. 7D, the tool, 720, has an ink pattern, 725, on its continuous, flexible surface, 721. The continuous, flexible surface of the tool is then distorted, 726 and 727. Referring to FIG. 7E, the tool, 730, has increased in volume, 733, and the surface area of the continuous, flexible surface, 731, has also increased. Moreover, the size of the ink pattern, 734, has been increased by the distorting, while its density has decreased. In some embodiments, such a distorting method can be performed by adding material to the internal volume of the tool using the filling and/or emptying means, 732.

Alternatively, the distorting can increase the density of the ink pattern. Referring to FIG. 7F, the tool, 735, has decreased in volume, 738, and the surface area of the continuous, flexible surface, 736, has also decreased. Moreover, the size of the ink pattern, 740, has been decreased by the distorting, while the density of the ink pattern has increased. In some embodiments, such a distorting method can be performed by removing material to the internal volume of the tool using the filling and/or emptying means, 737. The distorting method, 727, wherein the density of the ink pattern is increased can facilitate the formation patterns comprising high-density SAMs. Not being bound by any particular theory, this can be due to the increase in the ink density on the surface of the tool, a change in surface energy of the tool, an increased flexibility in the surface of the tool, and combinations thereof.

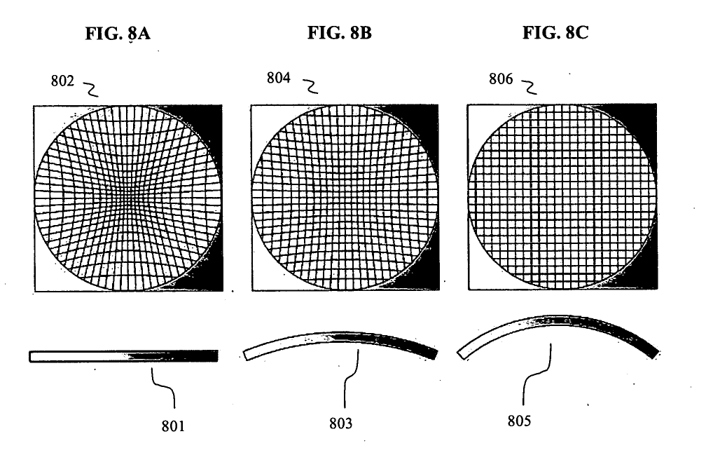

In some embodiments, an ink pattern on an applying means or the tool surface can be adjusted to compensate for deformation during either one of the applying step or the contacting step. For example, FIGS. 8A-8C provide a schematic representation of an ink pattern on an applying means. As the curvature of the applying means is varied, the spacing of the ink pattern changes in proportion to the change in the curvature of the surface. Referring to FIG. 8A, a surface suitable for transferring an ink pattern to a tool's surface (e.g., a silicon wafer), 801, is flat, and the density of an ink pattern thereon, as represented by the solid lines in the top-view of the surface, 802, is greatest in the center of the surface.

Referring to FIGS. 8B and 8C, the pattern density can be made more uniform by bending or flexing the substrate. The surface, 803 and 805, includes an ink pattern, 804 and 806, respectively, wherein the change in pattern density compared to that depicted in FIG. 8A is proportional to the change in the radius of curvature of the surface. The surface depicted in FIGS. 8B and 8C is flexed to modify a planar patterned surface to form a convex patterned surface, thereby reducing the pattern density. It is also possible to increase the pattern density on a surface prior to transferring the ink to the tool by bending a planar patterned surface to form a concave non-planar surface. This method permits the use of a single applying means to apply ink patterns of varying density to a wide variety of tools for use with the present invention. For example, patterning a substrate or substrates having a varying radius of curvature can be performed using a single applying means by varying the radius of curvature of the applying means in an amount proportional to the radius of curvature of the substrate to be patterned.

The contacting time between the tool and the substrate can be varied from about 1 second to about 10 minutes, for example.

Transfer of the ink from the tool to the substrate can be promoted by one or more interactions between the ink and the tool, between the ink and the substrate, between the tool and the substrate, and combinations thereof that promote adhesion of an ink to a substrate. Not being bound by any particular theory, adhesion of an ink to a substrate can be promoted by gravity, a Van der Waals interaction, a covalent bond, an ionic interaction, a hydrogen bond, a hydrophilic interaction, a hydrophobic interaction, a magnetic interaction, and combinations thereof. Conversely, the minimization of these interactions between an ink and the tool surface can facilitate transfer of the ink from the tool to the substrate.

In some embodiments, contacting the tool with a substrate can be facilitated by the application of pressure or vacuum to the backside of either or both the tool and/or the substrate. In some embodiments, the application of pressure or vacuum can ensure that the ink is substantially removed from between the surfaces of the tool and substrate. In some embodiments, the application of pressure or vacuum can ensure that there is conformal contact between the surfaces of the tool and the substrate. In some embodiments, the application of pressure or vacuum can minimize the presence of gas bubbles present between the surfaces of tool stamp and the substrate, or gas bubbles present in an indentation in the surface of the tool, or gas bubbles present in the ink. Not being bound by any particular theory, the removal of gas bubbles can facilitate in the reproducible formation of patterns having lateral dimensions of about 100 μm or less.

In some embodiments, at least one of the continuous, flexible surface of the tool, a surface of the applying means, the substrate, and combinations thereof can be selectively patterned, functionalized, derivatized, textured, or otherwise pre-treated. As used herein, “pre-treating” refers to chemically or physically modifying a substrate and/or surface of the tool prior to applying or reacting an ink. Pre-treating can include, but is not limited to, cleaning, oxidizing, reducing, derivatizing, functionalizing, exposing a surface to a reactive gas, plasma, thermal energy, ultraviolet radiation, and combinations thereof. Not being bound by any particular theory, pre-treating a surface can increase or decrease an adhesive interaction between an ink and a surface of the tool, and facilitate the formation of a pattern having a lateral dimension of about 100 μm or less. For example, derivatizing a surface with a polar functional group (e.g., oxidizing a surface) can promote the wetting of a surface by a hydrophilic ink and deter surface wetting by a hydrophobic ink. Moreover, hydrophobic and/or hydrophilic interactions can be used to prevent an ink from penetrating into the body of a stamp. For example, derivatizing a tool surface with a fluorocarbon functional group can facilitate the transfer of an ink from the tool to the substrate.

In some embodiments, an environmental condition can be controlled to facilitate at least one of the applying, the distorting, the contacting, the transferring, and combinations thereof. For example, the temperature, pressure, atmosphere, and combinations thereof can be controlled to facilitate forming a pattern on a substrate.

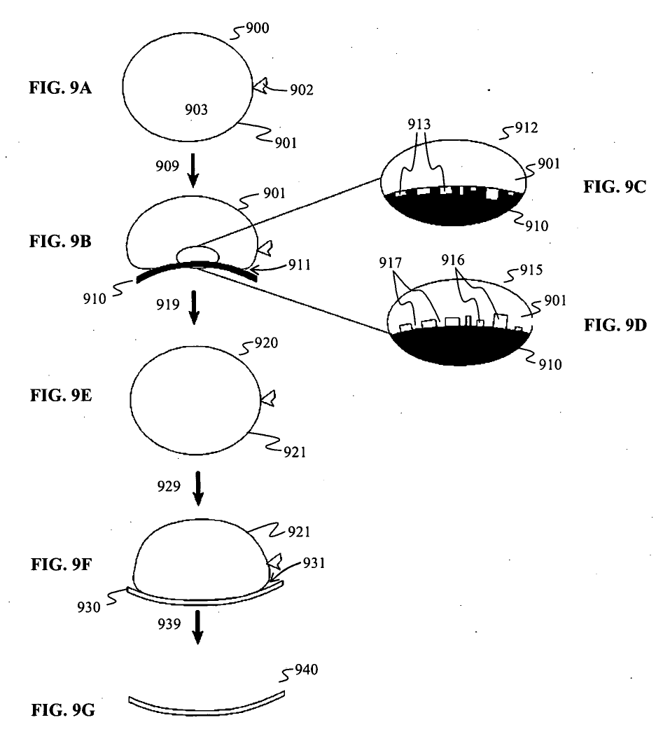

FIGS. 9A-9G provide a schematic cross-sectional representation of a patterning method of the present invention. Referring to FIG. 9A, a tool, 900, having a continuous, flexible surface, 901, enclosing a volume, 903, is provided. The tool can further include an optional filling and/or emptying means, 902, suitable for adding or removing a gas, liquid, solid, gel, and the like, and combinations thereof from the volume enclosed by the surface.

Referring to FIG. 9B, an ink is applied to the tool's surface, wherein the applying, 909, can include contacting the tool's surface, 901, with a second surface having an ink thereon, 910. In some embodiments, the applying step involves distorting the tool's surface. In some embodiments, the tool and inking surface (i.e., applying means) are conformally contacted, 911. FIGS. 9C and 9D provide magnified views of the applying step. FIG. 9C depicts a magnification, 912, of the applying wherein the tool surface, 901, is conformally contacted with a stamp surface, 910, having at least one indentation therein, 913, providing a pattern in the surface of the stamp. An ink is transferred to the tool surface in substantially the same pattern as is present in the surface of the stamp. FIG. 9D depicts a magnification, 915, of a second method for applying an ink pattern to the tool surface in which a stamp surface, 910, having a uniform ink coating thereon is contacted with the tool surface, 901, wherein the tool surface includes at least one indentation therein, 916, forming a pattern in the surface of the tool. Alternatively, the tool surface can include a raised pattern thereon, 917.

Not being bound by any particular theory, a benefit of applying the ink to the tool's surface by physical contact is to ensure radial propagation of the contact front by using a tool having a radius of curvature less than the radius of curvature of an applying means (e.g., a stamp and/or ink pad). Thus, this method can be readily applied to transfer patterns onto surfaces where air trapping between the stamp and substrate is an issue due to feature sizes or master pattern geometry.

The tool and the applying means are then separated, 919. Referring to FIG. 9E, depicted is the tool, 920, including a continuous, flexible surface, 921, having an ink pattern thereon. In some embodiments, the tool's surface is then distorted, for example, by filling or emptying the volume enclosed by the tool's surface with a gas, liquid, solid, gel, or combination thereof to increase or decrease the dimensions of the pattern on the tool's surface. For example, inflation and deflation can be effective means of decreasing or increasing the effective concentration of ink transferred to the substrate. In particular, increasing the ink concentration by reducing the surface area of the tool can be useful for forming a denser, more robust pattern comprising a SAM on a substrate.

The tool is then contacted, 929, with a substrate. Referring to FIG. 9F, the tool's surface, 921, is conformally contacted, 931, with a substrate, 930, for an amount of time sufficient to transfer the ink pattern from the tool to the substrate. In some embodiments, the substrate is non-planar, as depicted, and the radius of curvature of the tool is less than or equal to the radius of curvature of the substrate. Not being bound by any particular theory, this can enable conformal contact of the tool with the substrate.

The tool and the substrate are then separated, 939. Referring to FIG. 9G, the patterned substrate, 940, is prepared. In some embodiments, the patterned substrate undergoes additional method steps, such as reacting the pattern on the substrate, reacting an unpatterned area of the substrate, and combinations thereof (e.g., etching, metallization, chemical reaction, polymerization, etc.).

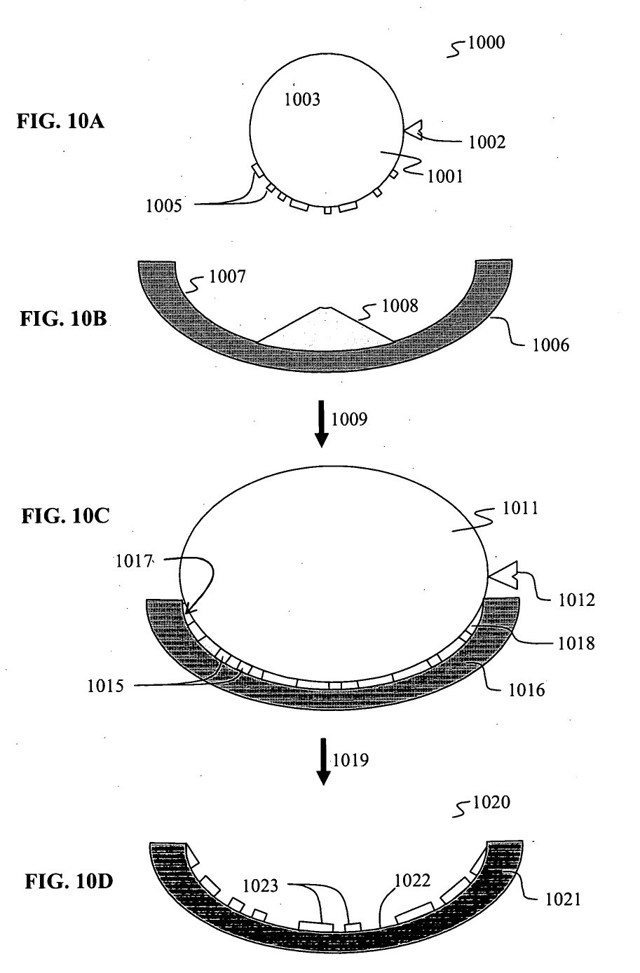

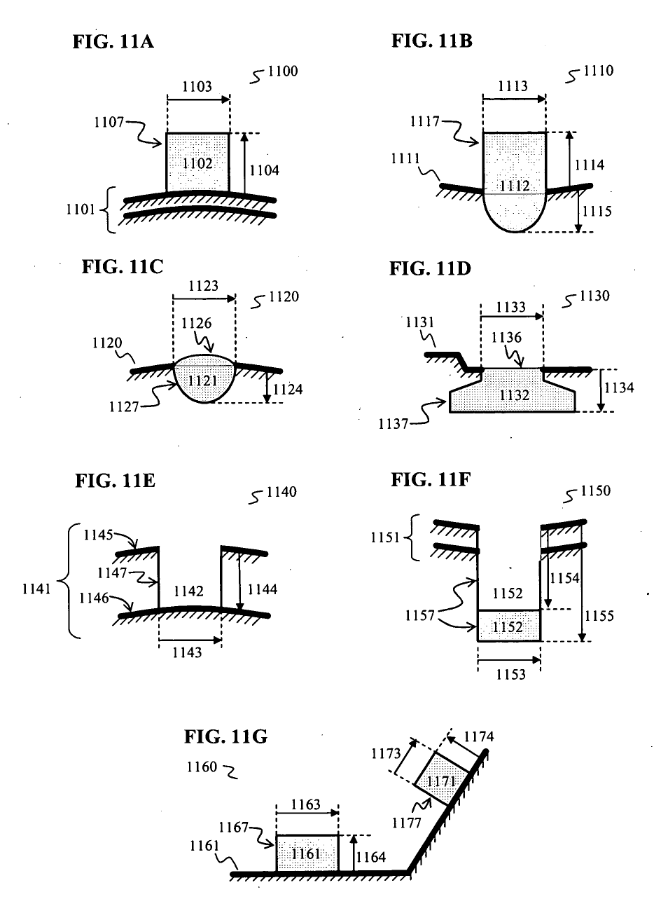

FIGS. 10A-10D provide a schematic, cross-sectional representation of a method of the present invention. Referring to FIG. 10A, a tool, 1000, having a continuous, flexible surface, 1001, enclosing a volume, 1003, is provided. The tool can further include an optional filling and/or emptying means, 1002, suitable for adding or removing a gas, liquid, solid, gel, and the like, and combinations thereof from the volume enclosed by the surface. The tool's surface further includes a raised pattern, 1005, thereon. Referring to FIG. 10B, also provided is a non-planar substrate, 1006, including a surface, 1007, having an ink, 1008, thereon. The ink on the substrate can be patterned or unpatterned. The tool and the non-planar substrate are then contacted, 1009. Referring to FIG. 10C, the raised pattern on the tool's surface, 1015, contacts a surface, 1017, of a substrate, 1016. In some embodiments, the raised pattern and the substrate are in conformal contact. The ink, 1018, is sequestered to areas of the substrate not contacted by the raised pattern. Furthermore, the tool's surface is distorted prior to, or during the contacting. For example, in the schematic depicted in FIGS. 10A and 10C, a positive pressure is homogeneously applied to the backside of the tool surface prior to contacting the substrate. In some embodiments, the tool's volume, 1011, can be increased or decreased by the distorting. The tool and the substrate are contacted for an amount of time sufficient to transfer the pattern from the tool to the ink on the substrate. The tool and the substrate are then separated, 1019. Referring to FIG. 10D the patterned substrate, 1020, is formed in which the substrate, 1021, has a pattern, 1023, thereon. An additional area of the substrate remains unpatterned, 1022.

In some embodiments, the method of the present invention further comprises reacting the ink with the substrate. Reacting the ink can occur during at least one of the contacting or after the separating. As used herein, “reacting” refers to initiating a chemical reaction comprising at least one of: reacting one or more components present in the ink with each other, reacting one or more components of an ink with a surface of a substrate, reacting one or more components of an ink with sub-surface region of a substrate, and combinations thereof. In some embodiments, reacting comprises applying an ink to a substrate (i.e., a reaction is initiated upon contact between an ink and a substrate).

In some embodiments, reacting the ink comprises a chemical reaction between the ink and a functional group on the substrate, or a chemical reaction between the ink and a functional group below the surface of the substrate. Thus, methods of the present invention comprise reacting an ink or a component of an ink not only with a substrate, but also with a substrate below its surface, thereby forming inset or inlaid patterns in a substrate. Not being bound by any particular theory, a component of an ink can react with a substrate by reacting on the surface of the substrate, or penetrating and/or diffusing into the substrate. In some embodiments, the penetration of an ink into a substrate can be facilitated by the application of physical pressure or vacuum to the either one or both of the tool and/or the substrate.

Reaction between an ink and a substrate can modify one or more properties of substrate, wherein the change in properties is localized to the portion of the substrate that reacts with the ink. For example, a reactive metal particle can penetrate into a substrate, and upon reacting, modify the substrate's conductivity. In some embodiments, a reactive component can penetrate into the substrate and react selectively to increase the porosity of the substrate in the areas (volumes) where reaction occurs. In some embodiments, a reactive component can selectively react with a crystalline substrate to increase or decrease its volume, or change the interstitial spacing of a crystalline lattice.

In some embodiments, reacting comprises chemically reacting a functional group on the surface of a substrate with an ink. In some embodiments, an ink can react with only the surface of a substrate (i.e., no penetration and reaction with a substrate occurs below its surface). In some embodiments, a patterning method wherein only the surface of a substrate is changed can be useful for subsequent self-aligned deposition reactions.

In some embodiments, reacting the ink with a substrate comprises a reaction that propagates into the substrate, as well as a reaction in the lateral plane of the substrate. For example, a reaction between an ink containing an etchant and a substrate can comprise penetration by the etchant into the substrate in the vertical direction (i.e., orthogonally to the substrate), such that the lateral dimensions of the lowest point of the pattern are approximately equal to the dimensions of the pattern at the plane of the substrate.

In some embodiments, etching reactions also occur laterally between an ink and a substrate, such that the lateral dimensions at the bottom of a pattern are more narrow than the lateral dimensions of the pattern at the plane of the substrate.

In some embodiments, an ink can be reacted via radiation applied to the ink through the backside of the substrate. In some embodiments, an ink can be activated via radiation applied through the backside of a tool.

In some embodiments, reacting the ink comprises removing solvent from the ink, thereby solidifying the ink, catalyzing cross-linking reactions between components of an ink, and combinations thereof. For inks containing solvents with a low boiling point (e.g., a boiling point below about 60° C., below about 80° C., or below about 100° C.), the solvent can be removed without heating of a substrate. Solvent removal can also be facilitated by heating the substrate, ink, or combinations thereof.

In some embodiments, reacting the ink comprises cross-linking components within the ink. Cross-linking reactions can be intramolecular or intermolecular, and can also occur between an ink and the substrate.

In some embodiments, reacting the ink comprises sintering metal particles present in the ink. Not being bound by any particular theory, sintering is a method in which metal particles join to form a continuous structure within a surface feature without melting. Sintering can be used to form both homogeneous and heterogeneous patterns.

In some embodiments, reacting comprises exposing an ink to a reaction initiator. Reaction initiators suitable for use with the present invention include, but are not limited to, thermal energy, radiation, acoustic waves, an oxidizing or reducing plasma, an electron beam, a stoichiometric chemical reagent, a catalytic chemical reagent, an oxidizing or reducing reactive gas, an acid or a base (e.g., a decrease or increase in pH), an increase or decrease in pressure, an alternating or direct electrical current, agitation, sonication, friction, and combinations thereof. In some embodiments, reacting comprises exposing an ink to multiple reaction initiators.

Radiation suitable for use as a reaction initiator can include, but is not limited to, electromagnetic radiation, such as microwave light, infrared light, visible light, ultraviolet light, x-rays, radiofrequency, and combinations thereof.

In some embodiments, the tool is removed from contact with a substrate before reacting the ink. In some embodiments, the tool is removed from contact with a substrate after reacting the ink. Not being bound by any particular theory, leaving the tool in place during a reacting step can ensure ink patterns are produced with the desired lateral dimensions. For example, removing the tool after the reacting can ensure that the ink does not spread on the substrate prior to or during reacting.

Reaction between an ink and substrate can modify one or more properties of an area of the substrate on which the reacting occurs. For example, a reactive metal particle can penetrate the surface of a substrate, and upon reacting with the substrate, modify its conductivity. In some embodiments, an ink can penetrate the surface of a substrate and react selectively to increase the porosity of the substrate in the areas (volumes) where reaction occurs. In some embodiments, a component can selectively react with a crystalline material to increase or decrease its volume, or change the interstitial spacing of a crystalline lattice.

Deviation from target specifications can also be minimized by the use of a substrate having an anisotropic composition or structure, such that reacting in the vertical direction is preferred compared to reacting in a lateral dimension (i.e., reacting in the plane of the substrate). Some materials are naturally anisotropic, while anisotropy can also be introduced by, for example, pre-treating a surface with a chemical or radiation, and combinations thereof.

### Features and Patterns

As used herein, a “feature” refers to an area of a substrate that is contiguous with, and can be distinguished from, one or more areas of a substrate surrounding the feature. A feature can be distinguished from an area of the substrate surrounding the feature based upon one or more of the topography, composition, and the like of the feature compared to a known topography and/or composition of an area of the substrate surrounding the feature.

As used herein, a “pattern” comprises a one-, two-, or three-dimensional arrangement of features on a substrate. Patterns of the present invention include, but are not limited to, repeating or irregular arrays of lines (e.g., parallel lines as in a grating or non-parallel lines as in a grid), arrays of isolated features (e.g., dots, pillars, holes, and the like having a regular or irregular spacing therebetween), and combinations thereof.

Features and patterns can be defined by their physical dimensions. All features have at least one lateral dimension. As used herein, a “lateral dimension” refers to a dimension of a feature measured at the surface of a substrate. One or more lateral dimensions of a feature define, or can be used to define, an area occupied by the feature, or an area occupied by a pattern comprising the feature. Typical lateral dimensions of features and patterns include, but are not limited to: length, width, radius, diameter, and combinations thereof.

All features and patterns also have at least one dimension that can be described by a vector that lies out of the surface of the substrate. As used herein, “elevation” refers to the largest vertical distance between a surface of a substrate and the highest or lowest point on a pattern. More generally, the elevation of an additive pattern refers to its highest point relative to the surface of the substrate, the elevation of a subtractive pattern refers to its lowest point relative to the surface of the substrate, and a conformal pattern has an elevation of zero (i.e., is at the same height as the surface of the substrate).

When an area of the substrate immediately surrounding a pattern is substantially planar, or non-planar with only a small degree of curvature (i.e., when a radius of curvature of a substrate is non-zero over a distance on the surface of less than about 100 μm), a lateral dimension of the pattern is the magnitude of a vector between two points located on opposite sides of a pattern at the surface of the substrate, wherein the vector is parallel to the surface of the substrate. In some embodiments, two points useful to determine a lateral dimension of a symmetric pattern also lie on a mirror plane of the symmetric pattern. In some embodiments, a lateral dimension of an asymmetric pattern can be determined by aligning the vector orthogonally to at least one edge of the pattern.

For example, FIGS. 11A-11G provide cross sectional schematic representations of features, the lateral dimension of these features is shown by the magnitude of the vectors 1104, 1114, 1124, 1134, 1144, 1154, 1164 and 1174, respectively.

Features produced by the methods of the present invention can generally be classified into three groups: additive features, conformal features, and subtractive features, based upon the elevation of the features relative to a surface of the substrate.

Features produced by a method of the present invention can be further classified into two-subgroups: penetrating and non-penetrating features, based upon whether the base of a features penetrates into a surface of the substrate. As used herein, the “penetration distance” refers to the distance between the lowest point of a feature and a surface of the substrate on and/or in which the feature is formed (e.g., the surface area adjacent a feature). More generally, the penetration distance of a feature refers to its lowest point relative to the surface of the substrate. Thus, a feature is a “penetrating” feature when the lowest point of a feature is located below the surface of the substrate on which the pattern is located, and a feature is a “non-penetrating” when the lowest point of the feature is located within or above the surface of the substrate. A non-penetrating feature has a penetration distance of zero.

As used herein, an “additive” feature refers to a feature having an elevation that includes at least a portion of the feature projecting from the surface of a substrate. Thus, the elevation of an additive pattern is greater than the elevation of the surrounding substrate. FIG. 11A provides a cross-sectional schematic diagram, 1100, of a non-planar composite substrate, 1101, having an “additive non-penetrating” feature, 1102, thereon. Referring to FIG. 11A, the additive non-penetrating feature, 1102, has a lateral dimension indicated by the magnitude of vector 1103, an elevation indicated by the magnitude of vector 1104, and a penetration distance of zero.

FIG. 11B provides a cross-sectional schematic representation of a non-planar substrate, 1110, having an “additive penetrating” pattern, 1111, thereon. Referring to FIG. 11B, the additive penetrating feature, 1112, has a lateral dimension indicated by the magnitude of vector 1113, an elevation indicated by the magnitude of vector 1114, and a penetration distance indicated by the magnitude of vector 1115.

As used herein, a “conformal” feature refers to a feature having an elevation that is substantially even with the surface of a substrate. Thus, a conformal pattern has substantially the same topography as the adjacent areas of the non-planar substrate. FIG. 11C provides a cross-sectional schematic diagram, 1120, of a non-planar substrate, 1121, having a “conformal penetrating” feature, 1122. Referring to FIG. 11C, the conformal penetrating feature, 1122, has a lateral dimension indicated by the magnitude of vector 1123, and a penetration distance indicated by the magnitude of vector 1124. The surface of the feature, 1126, differs slightly from the topography of the surrounding non-planar substrate, 1121, but is substantially the same.

FIG. 11D provides a cross-sectional schematic diagram, 1130, of a non-planar substrate, 1131, having a “conformal penetrating” feature, 1132, thereon. Referring to FIG. 11D, the conformal penetrating feature, 1132, has a lateral dimension indicated by the magnitude of vector 1133, an elevation of zero, and penetration distance indicated by the magnitude of vector, 1134. The surface of the feature, 1136, differs slightly from the topography of the surrounding substrate, 1131, but is substantially the same.

As used herein, a “subtractive” pattern refers to a feature having an elevation that is in the substrate (i.e., below the level of a substrate surface). FIG. 11E shows a cross-sectional schematic diagram, 1140, of a non-planar composite substrate, 1141, having a “subtractive non-penetrating” feature, 1142, thereon. The non-planar composite substrate, 1141, includes first material, 1145, and second material, 1146, that can be the same or different. In some embodiments, a first material, 1145 comprises a conductive and/or semiconductive material and a second material, 1146, comprises an insulator. The subtractive non-penetrating feature, 1142, has a lateral dimension indicated by the magnitude of vector 1143, an elevation indicated by the magnitude of vector 1144, and a penetration distance of zero.

FIG. 11F provides a cross-sectional schematic diagram, 1150, of a non-planar substrate, 1151, having a “subtractive penetrating” feature, 1152, thereon. The subtractive penetrating feature, 1152, has a lateral dimension indicated by the magnitude of vector 1153, an elevation indicated by the magnitude of vector 1154, and a penetration distance indicated by the magnitude of vector 1155.

FIG. 11G provides a cross-sectional schematic diagram, 1160, of a non-planar substrate, 1161, having additive non-penetrating features, 1161 and 1171, thereon. Referring to FIG. 11G, the additive non-penetrating features, 1161 and 1171, have lateral dimensions indicated by the magnitude of vectors 1163 and 1173, respectively; elevations indicated by the magnitude of vectors 1164 and 1174, respectively; and a penetration distance of zero.

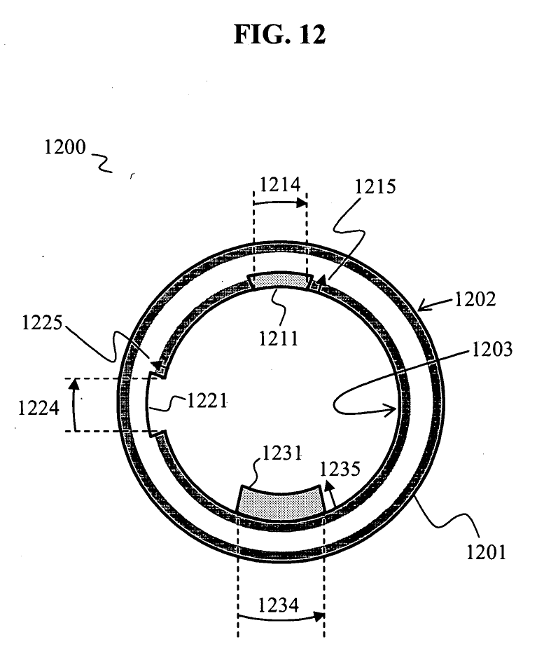

FIG. 12 displays a cross-sectional schematic diagram, 1200, of a non-planar substrate, 1201, having an exterior surface, 1202, and an interior surface, 1203. Exemplary non-limiting non-planar substrates corresponding to the cross-sectional schematic diagram include, but are not limited to, a spherical substrate, an ellipsoidal substrate, a conical substrate, and a cylindrical substrate. The interior surface, 1203, includes a conformal penetrating feature, 1211, a subtractive non-penetrating feature, 1221, and an additive non-penetrating feature, 1231. A lateral dimension of the conformal penetrating feature, 1211, is indicated by the magnitude of vector 1214. A lateral dimension of the conformal penetrating feature, 1221, is indicated by the magnitude of vector 1224. A lateral dimension of the conformal penetrating feature, 1231, is indicated by the magnitude of vector 1234. The conformal penetrating feature, 1211, has a penetration distance indicated by the magnitude of vector 1215. The subtractive non-penetrating feature, 1221, has an elevation indicated by the magnitude of vector 1225. The additive non-penetrating feature, 1231, has an elevation indicated by the magnitude of vector 1235.

A feature and a pattern comprising features produced by a method of the present invention have lateral and vertical dimensions that are typically defined in units of length, such as angstroms (Å), nanometers (nm), microns (μm), millimeters (mm), centimeters (cm), etc.

In some embodiments, a feature and/or a pattern produced by a method of the present invention has at least one lateral dimension of about 100 μm or less, about 40 nm to about 100 μm, about 40 nm to about 80 μm, about 40 nm to about 50 μm, about 40 nm to about 20 μm, about 40 nm to about 10 μm, about 40 nm to about 5 μm, about 40 nm to about 1 μm, about 100 nm to about 100 μm, about 100 nm to about 80 μm, about 100 nm to about 50 μm, about 100 nm to about 20 μm, about 100 nm to about 10 μm, about 100 nm to about 5 μm, about 100 nm to about 1 μm, about 500 nm to about 100 μm, about 500 nm to about 80 μm, about 500 nm to about 50 μm, about 500 nm to about 20 μm, about 500 nm to about 10 μm, about 500 nm to about 5 μm, about 500 nm to about 1 μm, about 1 μm to about 100 μm, about 1 μm to about 80 μm, about 1 μm to about 50 μm, about 1 μm to about 20 μm, about 1 μm to about 10 μm, about 1 μm to about 5 μm, or about 1 μm.

In some embodiments, a feature and/or a pattern produced by a method of the present invention has an elevation or penetration distance of about 3 Å to about 100 μm, about 3 Å to about 50 μm, about 3 Å to about 10 μm, about 3 Å to about 1 μm, about 3 Å to about 500 nm, about 3 Å to about 100 nm, about 3 Å to about 50 nm, about 3 Å to about 10 nm, about 3 Å to about 1 nm, about 1 nm to about 100 μm, about 1 nm to about 50 μm, about 1 nm to about 10 μm, about 1 nm to about 1 μm, about 1 nm to about 500 nm, about 1 nm to about 100 nm, about 1 nm to about 50 nm, about 1 nm to about 10 nm, about 10 nm to about 100 μm, about 10 nm to about 50 μm, about 10 nm to about 10 μm, about 10 nm to about 1 μm, about 10 nm to about 500 nm, about 10 nm to about 100 nm, about 10 nm to about 50 nm, about 50 nm to about 100 μm, about 50 nm to about 50 μm, about 50 nm to about 10 μm, about 50 nm to about 1 μm, about 50 nm to about 500 nm, about 50 nm to about 100 nm, about 100 nm to about 100 μm, about 100 nm to about 50 μm, about 100 nm to about 10 μm, about 100 nm to about 1 μm, or about 100 nm to about 500 nm above or below the surface of a surface.

In some embodiments, a feature and/or a pattern produced by a method of the present invention has an aspect ratio (i.e., a ratio of either one or both of the elevation and/or penetration distance to a lateral dimension) of about 100:1 to about 1:1,000,000, about 50:1 to about 1:100,000, about 40:1 to about 1:10,000, about 30:1 to about 1:1,000, about 20:1 to about 1:100, about 15:1 to about 1:50, about 10:1 to about 1:10, about 8:1 to about 1:8, about 5:1 to about 1:5, about 2:1 to about 1:2, or about 1:1.

In some embodiments, a feature and/or a pattern produced by the method of the present invention comprises rounded edges (i.e., is substantially lacking corners having edges 90° from one another).

Features and patterns can be further differentiated based upon their composition and utility. For example, patterns produced by a method of the present invention include structural patterns, conductive patterns, semi-conductive patterns, insulating patterns, and masking patterns.

As used herein, a “structural” pattern refers to a pattern having a composition similar or identical to the composition of the substrate on which the pattern is produced.

As used herein, a “conductive” pattern refers to a pattern having a composition that is electrically conductive, or electrically semi-conductive. Electrically semi-conductive patterns include those whose electrical conductivity can be modified based upon an external stimulus such as, but not limited to, an electrical field, a magnetic field, a temperature change, a pressure change, exposure to radiation, and combinations thereof.

As used herein, an “insulating” pattern refers to a pattern having a composition that is electrically insulating.

As used herein, a “masking” pattern refers to a pattern that has composition that is inert to reaction with a reagent that is reactive towards the areas of the substrate adjacent to and surrounding the pattern. Thus, a masking pattern can be used to protect a substrate or a selected area of a substrate during subsequent method steps, such as, but not limited to, etching, deposition, implantation, and surface treatment steps. In some embodiments, a masking feature is removed during or after subsequent method steps.

In some embodiments, the method of the present invention comprises: reacting the substrate adjacent to a pattern or exposing the substrate adjacent to a pattern to a reactive component that is unreactive towards the pattern. For example, after producing a pattern comprising a masking component, the substrate can be exposed to a reactive component to provide a second pattern on the substrate. In some embodiments, the reacting comprises contacting a reactive component with the surface of a substrate (i.e., a reaction is initiated upon contact between a reactive component and a substrate).

For example, a pattern can be formed on an area of a patterned substrate not covered by a masking pattern by performing at least one of: etching, electroplating, cleaning, chemically oxidizing, chemically reducing, exposing to ultraviolet light, exposing to thermal energy, exposing to a plasma, reacting with a composition containing at least one of: a conductive component, an insulating component, a conductive component and a reactive component, an etchant and a conductive component, an insulating component and a reactive component, an etchant and an insulating component, a conductive component and a masking component, and combinations thereof.

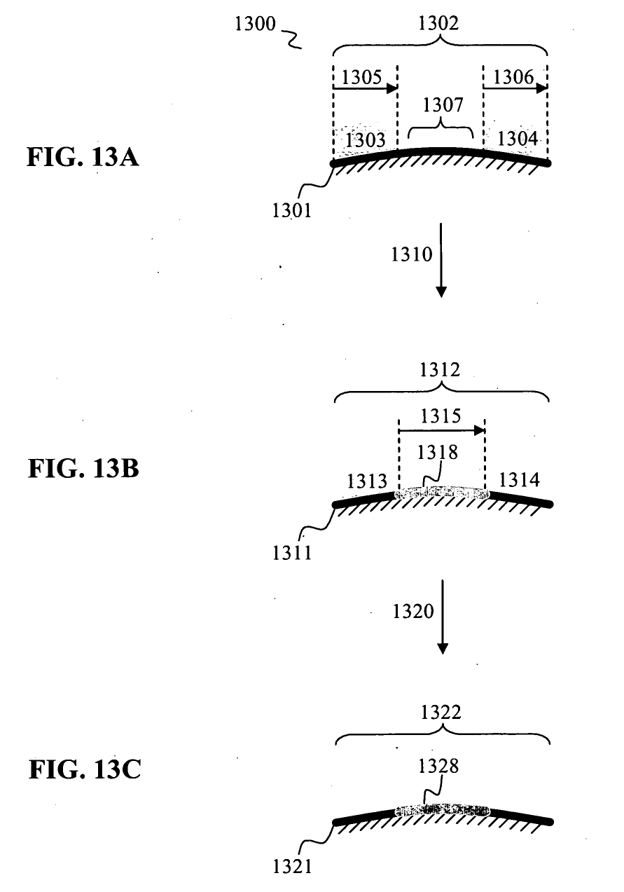

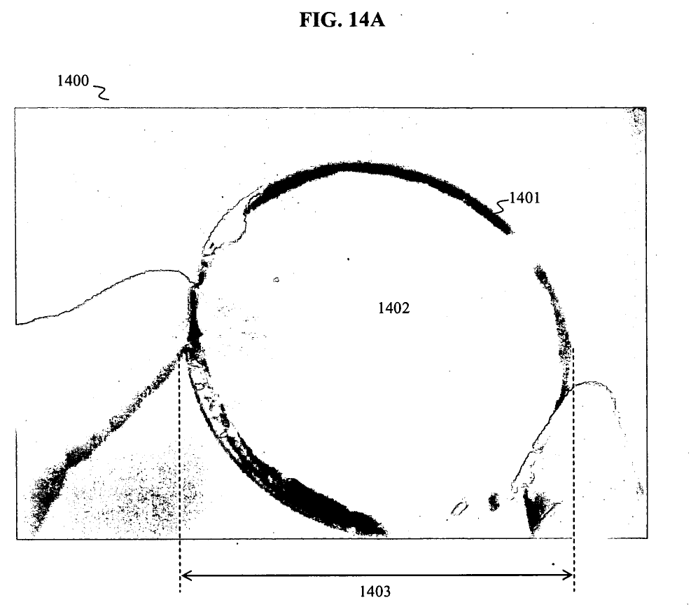

FIGS. 13A-13C provide a schematic cross-sectional representation, 1300, of a method of the present invention. Referring to FIG. 13A, a non-planar substrate, 1301, is patterned by a method of the present invention to provide a pattern, 1302, comprising features 1303 and 1304. The features, 1303 and 1304, have lateral dimensions indicated by the magnitude of vectors 1305 and 1306, respectively. An area of the substrate, 1307, is not covered by the pattern, 1302. The substrate is then exposed to a reactive component, 1310.

Referring to FIG. 13B, the reacting provided a feature, 1318, on the substrate, 1311, wherein the feature, 1318, has a lateral dimension indicated by the magnitude of vector 1315. The lateral dimension of the feature is determined by the spacing between features, 1313 and 1314, of the masking pattern, 1312. The feature, 1318, is a “conformal” and “non-penetrating” feature, which as used herein refer to a pattern that is substantially limited to the surface of a non-planar substrate. For example, exposure of an unpatterned area of a substrate with, for example, an oxidant, reducing agent, functionalizing agent, and the like, can be used to prepare a conformal non-penetrating feature. The conformal non-penetrating feature, 1318, has an elevation of zero and a penetration distance of zero. It is possible to similarly form a conformal-penetrating pattern, an additive-penetrating pattern, an additive-non-penetrating pattern, a subtractive penetrating pattern, and a subtractive non-penetrating pattern by similar methods.

Referring to FIG. 13C, the masking pattern can then optionally be removed, 1320, from the non-planar substrate, 1321, to provide a pattern, 1322, comprising a conformal non-penetrating feature, 1328.

In some embodiments, a pattern can be formed on a substrate by reacting a diffusive component with an area of the substrate not covered by a masking pattern. As used herein, a “diffusive component” refers to a compound or species that has a chemical interaction with a substrate. In some embodiments, a diffusive reactant penetrates into a substrate, and can transform, bind, or promote association with exposed functional groups on the surface of a substrate. Diffusive components can include, but are not limited to, ions, free radicals, metals, acids, bases, metal salts, organic reagents, and combinations thereof.

In some embodiments, the method of the present invention further comprises: removing the pattern from the substrate. Methods suitable for removing the pattern from the substrate include, but are not limited to, rinsing with an aqueous solvent, rinsing with an organic solvent, exposing to thermal energy, exposing to electromagnetic radiation, exposure to electrical current, and combinations thereof.

A lateral and/or vertical dimension of an additive or subtractive surface feature can be determined using an analytical method that can measure surface topography such as, for example, scanning mode atomic force microscopy (AFM) or profilometry. Conformal surface features cannot typically be detected by profilometry methods. However, if the surface of a conformal surface feature is terminated with a functional group whose polarity differs from that of the surrounding surface areas, a lateral dimension of the surface feature can be determined using, for example, tapping mode AFM, functionalized AFM, or scanning probe microscopy.

Patterns can also be identified based upon a property such as, but not limited to, conductivity, resistivity, density, permeability, porosity, hardness, and combinations thereof, and surface analytical methods can be employed to determine both the composition of the pattern, as well as the lateral dimension of the pattern, using, for example, scanning probe microscopy, scanning electron microscopy and/or transmission electron microscopy. Analytical methods suitable for determining the composition and lateral and vertical dimensions of a pattern include, but are not limited to, Auger electron spectroscopy, energy dispersive x-ray spectroscopy, micro-Fourier transform infrared spectroscopy, particle induced x-ray emission, Raman spectroscopy, x-ray diffraction, x-ray fluorescence, laser ablation inductively coupled plasma mass spectrometry, Rutherford backscattering spectrometry/Hydrogen forward scattering, secondary ion mass spectrometry, time-of-flight secondary ion mass spectrometry, x-ray photoelectron spectroscopy, and combinations thereof.

### EXAMPLES

As demonstrated by the following Examples, the present invention provides a cost-effective method to pattern a non-planar (e.g., curved) substrate with a pattern of metal lines having a regular and consistent spacing across the entire area of the patterned substrate. Furthermore, the Comparative Examples demonstrate that the use of previously known soft lithography methods was ineffective for patterning a non-planar substrate without distortion in the desired pattern.

### Comparative Example A

A flat elastomeric stamp was fabricated by the following method: a photoresist (SU-8, MICROCHEM CORP., Newton, Mass.) was blanket deposited onto a surface of a master (75 mm diameter silicon wafer). The photoresist was patterned using conventional photolithography to produce a grid comprising 25 μm wide by 25 μm deep trenches having a spacing of 400 μm. The patterned master was first treated with a fluorosilane and a liquid elastomeric precursor (poly(dimethylsiloxane) was spin-coated onto the master while rotating at 500 rpm. The resulting coated master was cured on a hotplate for 20 minutes at 85° C., cooled to room temperature (approximately 22° C.), and the resulting flat elastomeric stamp was peeled away from the master. The flat elastomeric stamp was approximately 100 μm thick, and the patterned surface included a grid of protrusions having a width of about 25 μm, a height of about 25 μm, and a line-to-line spacing of about 400 μm.

### Comparative Example B

A planar 50 mm diameter glass substrate was coated with a metal (50 nm thick gold) by vacuum deposition. The flat elastomeric stamp prepared in Example 1 was coated with a solution of hexadecane thiol (10 mM in ethanol) and dried under a stream of dry nitrogen. The dry, ink-coated elastomeric stamp was contacted with the planar gold-coated glass substrate for about a minute, during which time the hexadecane thiol was transferred to the metal-coated substrate to provide a self-assembled monolayer having a grid-pattern. The patterned metal-glass composite substrate was inserted into an etch bath TRANSENE® TFA Gold Etch (Transene Co., Inc., Danvers, Mass.), and the gold was removed from the glass substrate in areas that were not coated by the self-assembled monolayer.

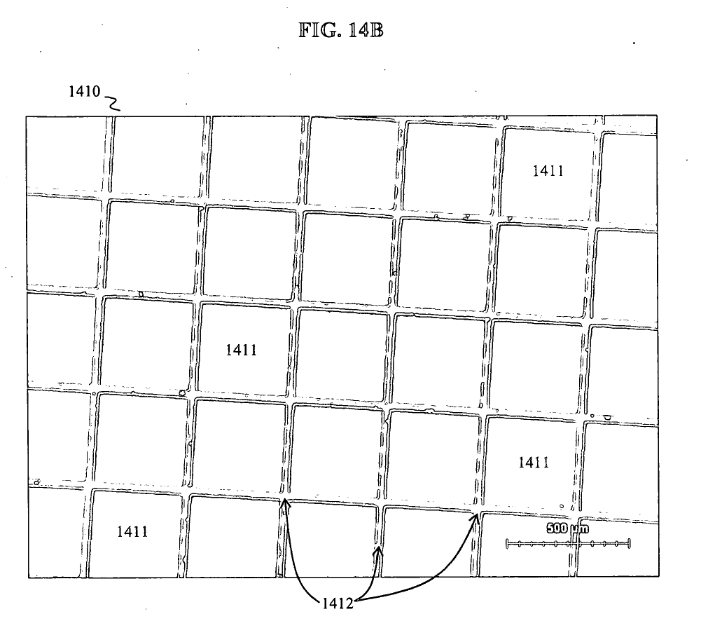

An optical image of the patterned substrate is provided in FIG. 14A. Referring to FIG. 14A, an image, 1400, shows the substrate, 1401, having a gold pattern, 1402, forming a grid thereon.

FIG. 14B provides an optical microscope image of the patterned substrate. Referring to FIG. 14B, an image, 1410, displays a glass substrate, 1411, having a grid pattern, 1412, or gold lines thereon. The gold lines, 1412, have a width of about 25 μm.

### Comparative Example C

The subtractive pattern prepared in Comparative Example B was used as a template for metal deposition. Metal patterns having a thickness of up to approximately 1 μm were deposited selectively onto the metal structures prepared in Comparative Example B. The self-assembled monolayer was removed from the gold under oxidative conditions (e.g., exposure to plasma or corona). A self-assembled monolayer forming material was then deposited onto the glass substrate (e.g., fluorinated or perfluorinated silane deposited by vapor deposition). A metal was then deposited selectively onto the metal regions of the substrate electroplating or electroless plating. Gold was electroplated onto the metal pattern using TRANSENE® TSG-250 Gold Electroplating Solution (Transene Company, Inc., Danvers, Mass.). Alternatively, silver was electrolessly deposited onto the metal pattern using HE-300 Unit silver deposition solution (Peacock Labs, Inc., Philadelphia, Pa.).

### Comparative Example D

A non-planar (convex) substrate having a grid comprising 25 μm high by 25 μm wide protrusions having a spacing of 400 μm was coated with an elastomeric precursor (poly(dimethylsiloxane)). The precursor was cured to provide an elastomeric stamp having a thickness of a several millimeters. The curved elastomeric stamp was removed from the substrate, derivatized with a fluorosilane and a solution of hexadecane thiol (10 mM in ethanol) was applied thereto, and dried under a stream of dry nitrogen. The ink-coated stamp was contacted with a non-planar substrate (a gold-coated, 50 mm diameter glass substrate having a 50 mm radius of curvature). The patterned non-planar substrate was then placed in a gold etch solution. The resulting patterned non-planar substrate included numerous defects due to over-etching of the gold. The defects were likely due to incomplete conformal contact between the curved stamp and the non-planar substrate.

The use of a flat stamp also led to distortions in the patterned substrate. For example a metal grid deposited from a flat stamp had a greater line spacing in the center of the pattern compared to the edges. This variation in line spacing poses significant problems for applications where a constant line spacing is crucial such as, but not limited to, electric field generation, magnetic field generation, and electromagnetic shielding applications.

### Example 1

A tool that includes a continuous, flexible surface was fabricated using the following method. A silicon substrate was patterned using a deep reactive ion etching (DRIE) method. A liquid elastomeric precursor (e.g., poly(dimethylsiloxane)) was poured onto the resulting patterned silicon substrate to form a thin film thereon having a thickness of approximately 100 μm. The elastomeric precursor was cured and the resulting continuous, flexible elastomeric surface was clamped between two circular gaskets. The volume enclosed by the gasketed continuous, flexible surface was placed in fluid communication with a pressure chamber, permitting the volume enclosed by the continuous, flexible surface to be increased or decreased, thereby distorting the pattern of the continuous, flexible surface. By increasing the internal pressure of the tool homogeneously (i.e., inflating the tool), the pattern on the tool's surface was enlarged. Conversely, by decreasing the internal pressure of the tool homogeneously (i.e., deflating the tool), the pattern on the tool's surface was reduced.

### Example 2

A tool of the present invention having a continuous, flexible surface was prepared by affixing a thin, flat elastomeric stamp to an inflatable bladder. A 100 μm-thick elastomeric stamp was prepared by spin-coating a photoresist (SU-8, MICROCHEM CORP., Newton, Mass.) onto a surface of a master (75 mm diameter silicon wafer). The photoresist was patterned using conventional photolithography to produce a grid comprising 25 μm wide by 25 μm deep trenches having a spacing of 400 μm. The patterned master was first treated with a fluorosilane and a liquid elastomeric precursor (poly(dimethylsiloxane) was spin-coated onto the master while rotating at 500 rpm. The resulting coated master was cured on a hotplate for 20 minutes at 85° C., cooled to room temperature (approximately 22° C.), and the resulting flat elastomeric stamp was peeled away from the master. The flat elastomeric stamp was approximately 100 μm thick, and the patterned surface included a grid of protrusions having a width of about 25 μm, a height of about 25 μm, and a line-to-line spacing of about 400 μm.

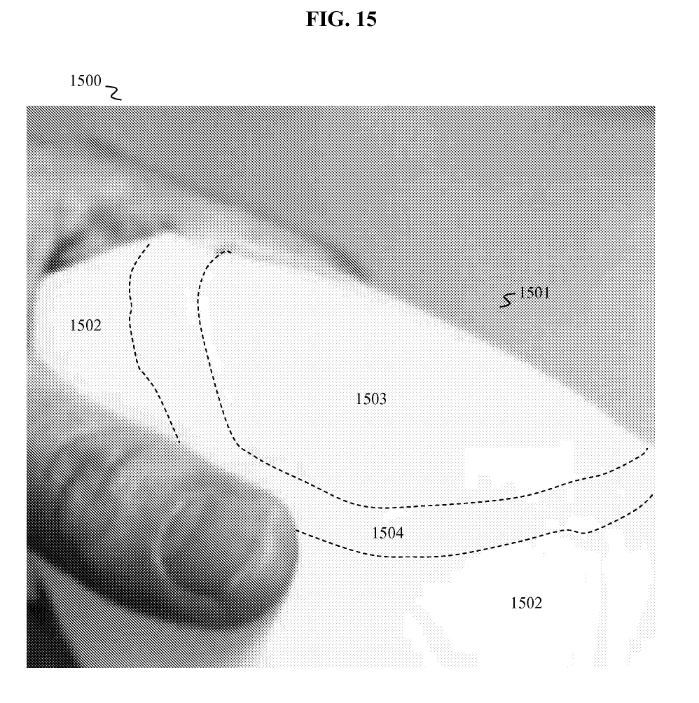

The elastomeric stamp was placed patterned-side-up onto a continuous, flexible surface (an air-filled latex bladder having a diameter of about 10 cm and a wall thickness of about 200 μm). The thin elastomeric stamp was affixed to the continuous, flexible surface of the bladder at the edges of the stamp using an epoxy adhesive to provide a tool having a continuous, flexible surface having a pattern on at least a portion of the surface. FIG. 15 provides an image, 1500, of the resulting tool. Referring to FIG. 15, the tool, 1501, comprises an inflatable bladder, 1502, having a thin elastomeric stamp, 1503, affixed thereto. The adhesive interaction between the thin elastomeric stamp and the bladder acted as a static ring, 1504, surrounding the patterned surface of the tool, 1503, when the bladder portion was inflated (i.e., as provided in FIG. 15). The thin elastomeric stamp can also be adhered uniformly to the bladder portion. As shown in FIG. 15, the bladder was inflated until the radius of curvature of the patterned surface of the tool was slightly less than the radius of curvature of the non-planar substrate to be patterned.

### Hypothetical Example 3

A continuous, flexible surface prepared by the procedure in Example 2 will be affixed to a permeable elastomeric bladder using a permeable adhesive. The elastomeric bladder will be filled with a liquid ink capable of diffusing through the bladder and the adhesive. The resulting tool will be capable of patterning multiple substrates without re-inking the continuous, flexible surface of the tool because the re-inking will occur via diffusion of the ink from the interior of the tool to its external surface.

### Example 4

An ink (10 mM hexadecanethiol in ethanol) was applied to the surface of the tool prepared in Example 1 by dip-coating in hexadecane thiol solution (10 mM in ethanol for 1 minute). The tool was removed from the ink and blown dry with nitrogen. The inked tool was then contacted for 30 seconds with a non-planar substrate (a 50 mm diameter glass substrate having a 50 mm radius of curvature) coated with a metal layer (50 nm thick gold). After the contacting, the tool was removed from the metal-coated substrate and the metal film was wet etched (in a solution containing 1.14 g thiourea and 4 g ferric nitrate in 500 mL deionized water). The etching time ranged from 7 to 12 minutes. The resulting patterned metal on glass substrate was then rinsed with water.

### Example 5

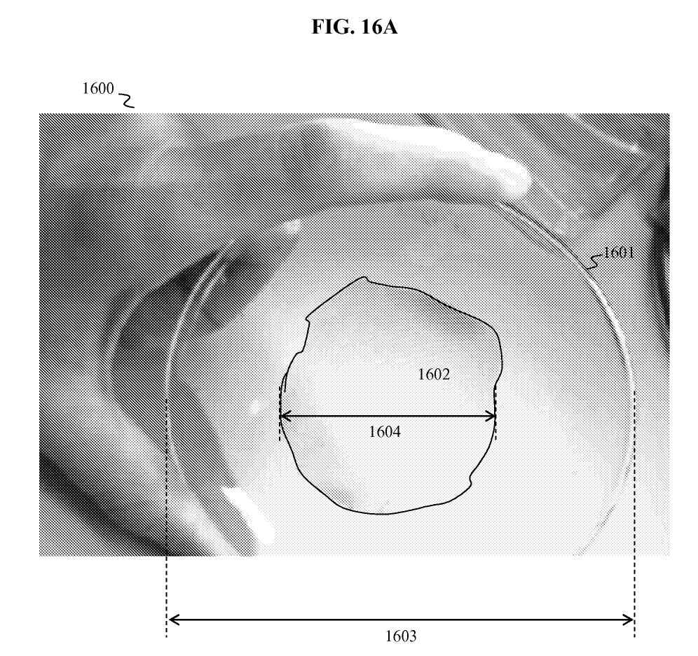

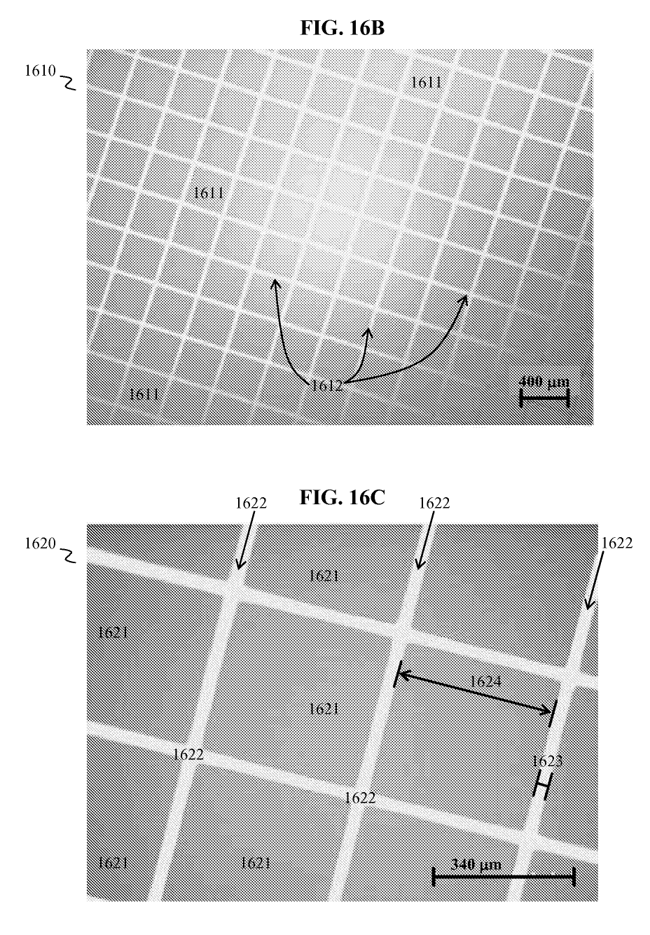

The patterning procedure of Example 4 was repeated for non-planar substrates having a diameter 75 mm and a radius of curvature of 75 mm, and having a diameter of 125 mm and a radius of curvature of 125 mm. FIG. 16A provides an image, 1600, of a non-planar glass substrate, 1601, having a diameter, 1603, of 125 mm. Referring to FIG. 16A, the patterned area, 1602, of the non-planar substrate had a diameter, 1604, of about 50 mm.

FIGS. 16B and 16C provide microscope images of the patterned non-planar substrate of FIG. 16A. Referring to FIG. 16B, an image, 1610, shows the non-planar substrate, 1611, having a grid of evenly spaced metal (gold) lines, 1612, thereon. The metal grid was substantially free of defects over the entire area of the pattern. Referring to FIG. 16C, a high-resolution image, 1620, shows the non-planar substrate, 1621, having a grid of evenly spaced metal (gold) lines, 1622, thereon. The metal lines have a height of 50 nm, a width, 1623, of about 25 μm, and a spacing, 1624, of about 400 μm.

### Example 6

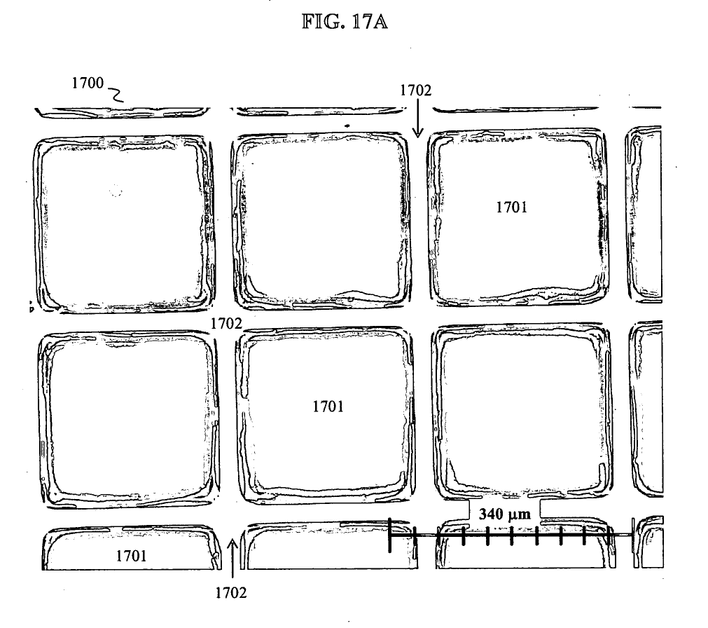

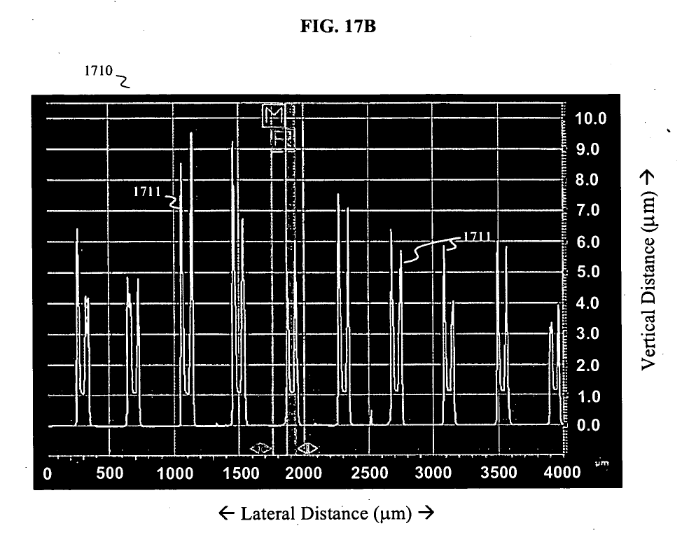

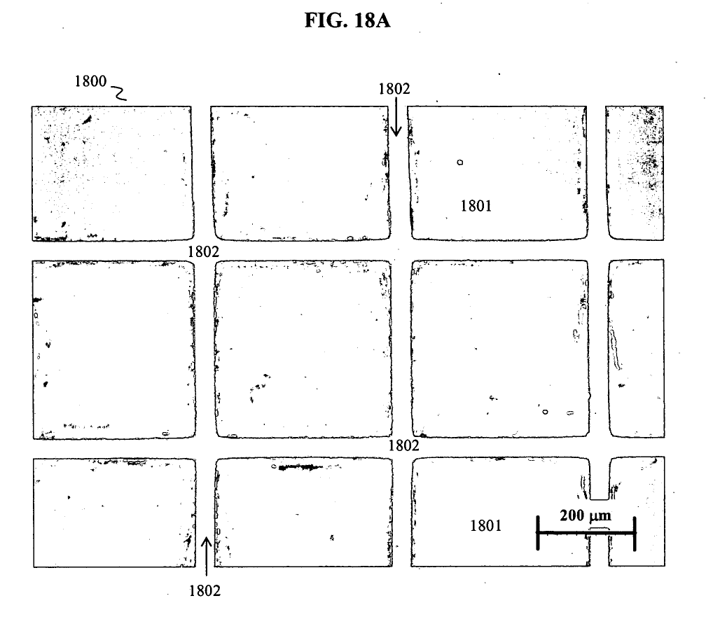

The resistivity of the metal grid can be modified by electrodepositing additional metal onto the metal grid. The patterned non-planar substrate was placed in an electroplating bath containing PURE GOLD SG-10 (Transene Co., Inc., Danvers, Mass.). A voltage (4.5 V) was applied to the metal grid for six minutes. FIG. 17A provides an optical microscope image, 1700, of the metal grid after electroplating. Referring to FIG. 17A, the glass substrate, 1701, is substantially unchanged, while the thickness and width of the metal grid, 1702, has increased. FIG. 17B provides a profilometry scan, 1710, of the electroplated metal grid of FIG. 17A. The peaks, 1711 in the scan indicate that metal deposited on the metal grid during the electrodepositing builds up more rapidly on the edges of the metal lines that in the center. After electrodepositing the metal lines had a thickness of about 1 μm at the center of the lines.

The electrodepositing not only increases the thickness of the metal lines (i.e., in the vertical dimension), but also increases the width of the metal lines. It was also noted that the electric field strength at the edges of the metal grid was stronger than the electric field strength in the middle of the metal grid. This resulted in uneven metal deposition across the surface of the metal grid (data not shown).

### Example 7

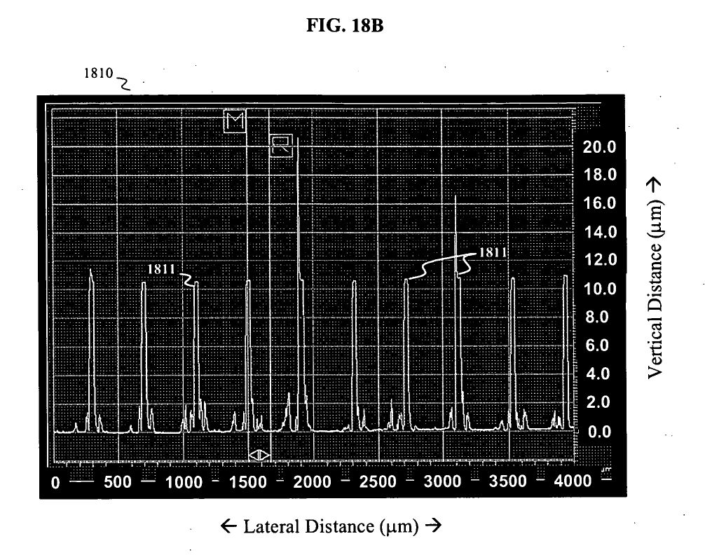

To ensure a uniform metal thickness across the area of the metal grid, an adhesive-backed strip was applied to the metal grid to lift-off the thickened edges of the metal lines. The lift-off method removed most of the peaks. FIG. 18 provides an optical microscope image, 1800, of the metal grid after the electroplated metal lines were treated with a lift-off adhesive. Referring to FIG. 18A, the glass substrate, 1801, is substantially unchanged, while the uniformity of the thickness and width of the metal grid, 1802, has increased substantially compared to FIG. 17A. FIG. 18B provides a profilometry scan, 1810, of the electroplated metal grid of FIG. 18A. The peaks, 1811 in the scan indicate that height variation in the edges of the metal lines has been substantially eliminated.

Alternative methods for removing height variation from the metal lines include etching the peaks of the metal lines via contact etching, an etch bath, and the like. The thickness of the metal lines can be controlled by selecting the thickness of the self-assembled monolayer deposition.

### Example 8

An inked tool suitable for forming a pattern on a substrate was prepared by the following method. A patterned ink pad was prepared by electrodepositing a metal pattern onto a metal substrate (e.g., silicon). A liquid elastomeric precursor (e.g., poly(dimethylsiloxane)) was poured onto the pattered metal substrate to form a thin film thereon having a thickness of approximately 10 mm. The elastomeric precursor was then cured and the resulting patterned elastomeric ink pad was removed from the patterned metal substrate. An ink (e.g., 10 mM hexadecathiol in ethanol) was applied to the patterned surface of the elastomeric ink pad using a cotton swab. The ink was then dried under a stream of hot air. A tool having a continuous, flexible surface (e.g., a latex bladder) was then contacted with the inked elastomeric ink pad for an amount of time sufficient to transfer the pattern from the ink pad to the continuous, flexible surface (i.e., about 1 minute). The ink pattern on the continuous, flexible surface of the tool was then either distorted by inflating or deflating the latex bladder, and then contacted with a non-planar substrate for an amount of time sufficient to transfer the ink pattern from the tool to the non-planar substrate. The patterned non-planar substrate was then further plated according to the procedures outlined in Example 6.

### CONCLUSION

These Examples illustrate possible embodiments of the present invention. While various embodiments of the present invention have been described above, it should be understood that they have been presented by way of example only and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method for patterning a substrate, the method comprising:
providing a tool including a continuous, flexible surface having an area, wherein the continuous, flexible surface does not include a rigid backing layer;
applying an ink to at least a portion of the continuous, flexible surface of the tool to form an ink pattern thereon;
applying homogeneous pressure to a backside of the continuous, flexible surface to distort the surface area of the continuous, flexible surface;
conformally contacting at least a portion of the distorted continuous, flexible surface of the tool with a non-planar substrate; and
transferring the ink pattern from the distorted continuous, flexible surface of the tool to the non-planar substrate, wherein the pattern on the non-planar substrate includes at least one feature having a lateral dimension of about 100 μm or less.

2. The method of claim 1, wherein the non-planar substrate comprises an interior surface of at least one of: a spheroid, a hemispheroid, an ellipsoid, a cone, a polyhedron, a cylinder, a toroid, a trigonal pyramid, and a square pyramid.

3. The method of claim 1, wherein the continuous, flexible surface of the tool is non-porous and substantially impermeable to the ink.

4. The method of claim 1, wherein the continuous, flexible surface of the tool includes a raised pattern thereon.

5. The method of claim 1, wherein the applying an ink to at least a portion of the continuous, flexible surface of the tool further comprises applying the ink from a reservoir enclosed within the volume of the continuous, flexible surface of the tool, wherein the reservoir is configured to receive an ink, and wherein the reservoir is in fluid communication with at least a portion of the continuous, flexible surface.

6. The method of claim 1, wherein the distorting comprises increasing a volume enclosed by the continuous, flexible surface of the tool.

7. The method of claim 1, wherein the applying an ink comprises contacting the continuous, flexible surface of the tool with a stamp having a surface including at least one indentation therein, the indentation being contiguous with and defining a pattern in the surface of the stamp.

8. The method of claim 1, wherein the distorting comprises applying homogeneous pressure to the continuous, flexible surface of the tool.

9. The method of claim 1, wherein the transferring comprises forming a self-assembled monolayer on an area of the substrate defined by the pattern.

10. A method for patterning a non-planar substrate, the method comprising:
providing a tool including a continuous, flexible surface having an area;
applying an ink to at least a portion of the continuous, flexible surface of the tool to form an ink pattern thereon;
applying homogeneous pressure to a backside of the continuous, flexible surface to distort the surface area of the continuous, flexible surface of the tool while restraining an edge of the continuous, flexible surface;
conformally contacting at least a portion of the distorted continuous, flexible surface of the tool with a non-planar substrate; and
transferring the ink pattern from the distorted continuous, flexible surface of the tool to the non-planar substrate, wherein the pattern on the non-planar substrate has a lateral dimension of about 100 μm or less.

11. The method of claim 10, wherein the substrate comprises an inner surface of at least one of: a spheroid, a hemispheroid, an ellipsoid, a cone, a polyhedron, a cylinder, a toroid, a trigonal pyramid, and a square pyramid.

12. The method of claim 10, wherein the continuous, flexible surface of the tool includes at least one indentation therein, the indentation being contiguous with and defining a pattern in the continuous, flexible surface.

13. The method of claim 10, wherein the applying an ink comprises contacting the continuous, flexible surface of the tool with a elastomeric stamp having a surface including at least one indentation therein, the indentation being contiguous with and defining a pattern in the surface of the stamp.

14. The method of claim 10, wherein the transferring comprises forming a self-assembled monolayer on an area of the substrate defined by the pattern.

15. The method of claim 10, wherein the ink comprises a species suitable for forming a self-assembled monolayer on a substrate, and the pattern on the substrate includes a feature having a lateral dimension of about 10 μm or less.

16. A method for patterning a substrate, the method comprising:
providing a tool including a continuous, flexible surface having a raised pattern thereon;
applying an ink to at least a portion of a substrate;
applying homogeneous pressure to a backside of the continuous, flexible surface to distort the raised pattern of the continuous, flexible surface of the tool; and
patterning the ink on the substrate by conformally contacting at least a portion of the distorted raised pattern of the tool with the inked substrate, wherein the resulting pattern on the substrate includes a feature having a lateral dimension of about 100 μm or less.

17. The method of claim 16, further comprising: removing the distorted raised pattern from the non-planar substrate.

18. The method of claim 16, wherein the substrate is non-planar and comprises an inner surface of at least one of: a spheroid, a hemispheroid, an ellipsoid, a cone, a polyhedron, a cylinder, a toroid, a trigonal pyramid, and a square pyramid.

19. The method of claim 16, wherein the distorting comprises applying homogeneous pressure to the continuous, flexible surface of the tool.

20. The method of claim 16, wherein the ink comprises a polymeric species, and the pattern on the substrate includes a feature having a lateral dimension of about 10 μm or less.

21. A method to prepare a patterning tool having a continuous, flexible surface including at least one protrusion thereon, the method comprising:
applying an elastomeric precursor to a master having a predetermined relief pattern thereon;
contacting a continuous, flexible surface with the elastomeric precursor;
curing the elastomeric precursor to provide a patterning tool including at least one elastomeric protrusion thereon, wherein the at least one protrusion corresponds to the relief pattern of the master, and the continuous, flexible surface and the at least one protrusion have a Young's modulus that is substantially identical; and
removing the patterning tool from the master.
